(19) United States
(12) Patent Application Publication
(10) Pub. No.: US 2023/0198708 A1
(43) Pub. Date: Jun. 22, 2023

(54) METHOD AND DEVICE FOR PERFORMING POSITIONING ON BASIS OF SIGNAL FROM NEIGHBOR TERMINAL IN WIRELESS COMMUNICATION SYSTEM

(71) Applicant: LG ELECTRONICS INC., Seoul (KR)

(72) Inventors: Taehowan HONG, Seoul (KR); Young Dae KIM, Seoul (KR); Byounggill KIM, Seoul (KR); Hyunmin KIM, Seoul (KR)

(21) Appl. No.: 17/921,031

(22) PCT Filed: Apr. 19, 2021
(86) PCT No.: PCT/KR2021/004852

§ 371 Date: Oct. 24, 2022

(30) Foreign Application Priority Data
Apr. 27, 2020 (KR) 10-2020-0050494
May 25, 2020 (KR) 10-2020-0062505
Sep. 2, 2020 (KR) 10-2020-0111804

(51) Int. Cl. H04L 5/00; H04W 64/00

(52) U.S. Cl. CPC H04L 5/0051; H04W 64/00

(57) ABSTRACT

Positioning is performed based on a signal from a terminal in a wireless communication system. A method of operating a terminal may comprise transmitting a first message requesting addition of a positioning reference signal (PRS) source to a base station, receiving, from the base station, a second message including information related to at least one other terminal to transmit a PRS, receiving at least one PRS transmitted by the at least one other terminal through a resource allocated by the base station, and performing an operation for positioning based on the at least one PRS.

### TECHNICAL FIELD

The present disclosure relates to a wireless communication system and, more particularly, to a method and device for performing positioning based on a signal from an adjacent terminal in a wireless communication system.

### BACKGROUND ART

A wireless communication system is a multiple access system that supports communication of multiple users by sharing available system resources (e.g., a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (mMTC), Ultra-Reliable and Low Latency Communication (URLLC), and so on, may be referred to as a new radio access technology (RAT) or new radio (NR). Herein, the NR may also support vehicle-to-everything (V2X) communication.

### DISCLOSURE

### Technical Problem

The present disclosure relates to a method and device for efficiently performing positioning in a wireless communication system.

The present disclosure relates to a method and device for sufficiently securing a signal source for positioning in a wireless communication system.

The present disclosure relates to a method and device for requesting addition of a signal source in preparation for a case where the number of signal sources for positioning is insufficient in a wireless communication system.

The present disclosure relates to a method and device for using a terminal as a signal source for positioning in a wireless communication system.

The present disclosure relates to a method and device for solving accumulation of errors caused by using a terminal as a signal source for positioning in a wireless communication system.

The present disclosure relates to a method and device for evaluating reliability of a signal source for positioning in a wireless communication system.

The technical objects to be achieved in the present disclosure are not limited to the above-mentioned technical objects, and other technical objects that are not mentioned may be considered by those skilled in the art through the embodiments described below.

### Technical Solution

As an example of the present disclosure, a method of operating a terminal in a wireless communication system may comprise transmitting a first message requesting addition of a positioning reference signal (PRS) source to a base station, receiving, from the base station, a second message including information related to at least one other terminal to transmit a PRS, receiving at least one PRS transmitted by the at least one other terminal through a resource allocated by the base station, and performing an operation for positioning based on the at least one PRS.

As an example of the present disclosure, a method of operating a base station in a wireless communication system may comprise receiving a first message requesting addition of a positioning reference signal (PRS) source from a first terminal, determining a second terminal to transmit a PRS for positioning of the first terminal, transmitting scheduling information for transmitting the PRS to the second terminal, and transmitting a second message including information related to the second terminal to the first terminal.

As an example of the present disclosure, a method of operating a terminal in a wireless communication system may comprise receiving, from a base station, scheduling information for transmission of a positioning reference signal (PRS) for positioning of another terminal and transmitting the PRS based on the scheduling information.

As an example of the present disclosure, a terminal in a wireless communication system may comprise a transceiver and a processor coupled to the transceiver. The processor may be configured to transmit a first message requesting addition of a positioning reference signal (PRS) source to a base station, to receive, from the base station, a second message including information related to at least one other terminal to transmit a PRS, to receive at least one PRS transmitted by the at least one other terminal through a resource allocated by the base station, and to perform an operation for positioning based on the at least one PRS.

As an example of the present disclosure, a base station in a wireless communication system may comprise a transceiver and a processor coupled to the transceiver. The processor may be configured to receive a first message requesting addition of a positioning reference signal (PRS) source from a first terminal, to determine a second terminal to transmit a PRS for positioning of the first terminal, to transmit scheduling information for transmitting the PRS to the second terminal, and to transmit a second message including information related to the second terminal to the first terminal.

As an example of the present disclosure, a terminal in a wireless communication system may comprise a transceiver and a processor coupled to the transceiver. The processor may be configured to receive, from a base station, scheduling information for transmission of a positioning reference signal (PRS) for positioning of another terminal and to transmit the PRS based on the scheduling information.

As an example of the present disclosure, a device may comprise at least one memory and at least one processor functionally coupled to the at least one memory. The at least one processor may control the device to transmit a first message requesting addition of a positioning reference signal (PRS) source to a base station, to receive, from the base station, a second message including information related to at least one other terminal to transmit a PRS, to receive at least one PRS transmitted by the at least one other terminal through a resource allocated by the base station, and to perform an operation for positioning based on the at least one PRS.

As an example of the present disclosure, a non-transitory computer-readable medium storing at least one instruction may comprise the at least one instruction executable by a processor. The at least one instruction may instruct a device to transmit a first message requesting addition of a positioning reference signal (PRS) source to a base station, to receive, from the base station, a second message including information related to at least one other terminal to transmit a PRS, to receive at least one PRS transmitted by the at least one other terminal through a resource allocated by the base station, and to perform an operation for positioning based on the at least one PRS.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

### Advantageous Effects

As is apparent from the above description, the embodiments of the present disclosure have the following effects.

According to the present disclosure, positioning of a user equipment (UE) in a wireless communication system can be effectively performed. In particular, even in a situation where fixed signal sources are not sufficient, positioning can be performed.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates a structure of a wireless communication system, in accordance with an embodiment of the present disclosure.

FIG. 2 illustrates a functional division between an NG-RAN and a SGC, in accordance with an embodiment of the present disclosure.

FIG. 3 illustrates a radio protocol architecture, in accordance with an embodiment of the present disclosure.

FIG. 4 illustrates a structure of a radio frame in an NR system, in accordance with an embodiment of the present disclosure.

FIG. 5 illustrates a structure of a slot in an NR frame, in accordance with an embodiment of the present disclosure.

FIG. 6 illustrates an example of a BWP, in accordance with an embodiment of the present disclosure.

FIGS. 7A and 7B illustrate a radio protocol architecture for a SL communication, in accordance with an embodiment of the present disclosure.

FIG. 8 illustrates a synchronization source or synchronization reference of V2X, in accordance with an embodiment of the present disclosure.

FIGS. 9A and 9B illustrate a procedure of performing V2X or SL communication by a terminal based on a transmission mode, in accordance with an embodiment of the present disclosure.

FIGS. 10A to 10C illustrate three cast types, in accordance with an embodiment of the present disclosure.

FIG. 11 illustrates a resource unit for channel busy ratio (CBR) measurement, in accordance with an embodiment of the present disclosure;

FIG. 12 illustrates an example of an architecture in a 5G system, for positioning a UE which has accessed an NG-RAN or an evolved UMTS terrestrial radio access network (E-UTRAN), in accordance with an embodiment of the present disclosure;

FIG. 13 illustrates an implementation example of a network for positioning a UE, in accordance with an embodiment of the present disclosure;

FIG. 14 illustrates exemplary protocol layers used to support LTE positioning protocol (LPP) message transmission between a location management function (LMF) and a UE, in accordance with an embodiment of the present disclosure;

FIG. 15 illustrates exemplary protocol layers used to support NR positioning protocol A (NRPPa) protocol data unit (PDU) transmission between an LMF and an NG-RAN node, in accordance with an embodiment of the present disclosure;

FIG. 16 illustrates an observed time difference of arrival (OTDOA) positioning method, in accordance with an embodiment of the present disclosure;

FIG. 17 illustrates a concept of a positioning technique for an in-coverage terminal according to an embodiment of the present disclosure.

FIG. 18 illustrates a concept of a positioning technique for an out-of-coverage terminal according to an embodiment of the present disclosure.

FIGS. 19A and 19B illustrate examples of criteria for positioning reference signal (PRS) source selection according to an embodiment of the present disclosure.

FIG. 20 illustrates an example of a method of operating a terminal requesting a PRS according to an embodiment of the present disclosure.

FIG. 21 illustrates an example of a method of operating a road side unit (RSU) that provides a PRS source according to an embodiment of the present disclosure.

FIG. 22 illustrates an example of a method of operating a terminal transmitting a PRS according to an embodiment of the present disclosure.

FIG. 23 illustrates an example of a method of operating a terminal for determining whether to request addition of a PRS source, according to an embodiment of the present disclosure.

FIG. 24 illustrates an example of a procedure for positioning in an in-coverage case, according to an embodiment of the present disclosure.

FIG. 25 illustrates another example of a procedure for positioning in an in-coverage case, according to an embodiment of the present disclosure.

FIG. 26 illustrates an example of a procedure for positioning in an out-of-coverage case according to an embodiment of the present disclosure.

FIG. 27 illustrates another example of a procedure for positioning in an out-of-coverage case according to an embodiment of the present disclosure.

FIG. 28 illustrates a concept of reliability for a positioning value according to an embodiment of the present disclosure.

FIG. 29 illustrates an example of calculating a reliability coefficient for a positioning value according to an embodiment of the present disclosure.

FIG. 30 illustrates an example of a method of operating a terminal for determining a reliability coefficient according to an embodiment of the present disclosure.

FIG. 31 illustrates a communication system, in accordance with an embodiment of the present disclosure.

FIG. 32 illustrates wireless devices, in accordance with an embodiment of the present disclosure.

FIG. 33 illustrates a signal process circuit for a transmission signal, in accordance with an embodiment of the present disclosure.

FIG. 34 illustrates a wireless device, in accordance with an embodiment of the present disclosure.

FIG. 35 illustrates a hand-held device, in accordance with an embodiment of the present disclosure.

FIG. 36 illustrates a car or an autonomous vehicle, in accordance with an embodiment of the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the present specification, “A or B” may mean “only A”, “only B” or “both A and B.” In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDDCH” may be proposed as an example of the “control information”. In addition, when indicated as “control information (i.e., PDCCH)”, it may also mean that “PDCCH” is proposed as an example of the “control information”.

In the following description, ‘when, if, or in case of’ may be replaced with ‘based on’.

A technical feature described individually in one figure in the present specification may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

For terms and techniques not specifically described among terms and techniques used in the present disclosure, reference may be made to a wireless communication standard document published before the present disclosure is filed. For example, the following document may be referred to.

(1) 3GPP LTE
3GPP TS 36.211: Physical channels and modulation
3GPP TS 36.212: Multiplexing and channel coding
3GPP TS 36.213: Physical layer procedures
3GPP TS 36.214: Physical layer; Measurements
3GPP TS 36.300: Overall description
3GPP TS 36.304: User Equipment (UE) procedures in idle mode
3GPP TS 36.314: Layer 2—Measurements
3GPP TS 36.321: Medium Access Control (MAC) protocol
3GPP TS 36.322: Radio Link Control (RLC) protocol
3GPP TS 36.323: Packet Data Convergence Protocol (PDCP)
3GPP TS 36.331: Radio Resource Control (RRC) protocol

(2) 3GPP NR (e.g. 5G)
3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: Overall description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description

Communication System Applicable to the Present Disclosure

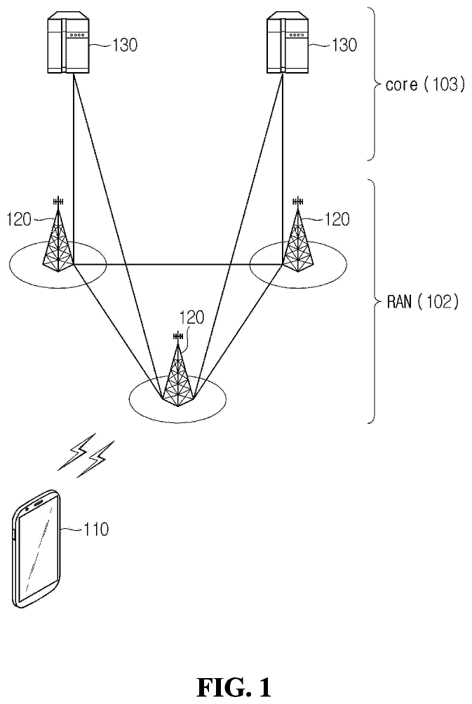

FIG. 1 illustrates a structure of a wireless communication system according to an embodiment of the present disclosure. The embodiment of FIG. 1 may be combined with various embodiments of the present disclosure.

Referring to FIG. 1, a wireless communication system includes a radio access network (RAN) 102 and a core network 103. The radio access network 102 includes a base station 120 that provides a control plane and a user plane to a terminal 110. The terminal 110 may be fixed or mobile, and may be called other terms such as a user equipment (UE), a mobile station (MS), a subscriber station (SS), a mobile subscriber station (MSS), a mobile terminal, an advanced mobile station (AMS), or a wireless device. The base station 120 refers to a node that provides a radio access service to the terminal 110, and may be called other terms such as a fixed station, a Node B, an eNB (eNode B), a gNB (gNode B), an ng-eNB, an advanced base station (ABS), an access point, a base transceiver system (BTS), or an access point (AP). The core network 103 includes a core network entity 130. The core network entity 130 may be defined in various ways according to functions, and may be called other terms such as a core network node, a network node, or a network equipment.

Components of a system may be referred to differently according to an applied system standard. In the case of the LTE or LTE-A standard, the radio access network 102 may be referred to as an Evolved-UMTS Terrestrial Radio Access Network (E-UTRAN), and the core network 103 may be referred to as an evolved packet core (EPC). In this case, the core network 103 includes a Mobility Management Entity (MME), a Serving Gateway (S-GW), and a packet data network-gateway (P-GW). The MME has access information of the terminal or information on the capability of the terminal, and this information is mainly used for mobility management of the terminal. The S-GW is a gateway having an E-UTRAN as an endpoint, and the P-GW is a gateway having a packet data network (PDN) as an endpoint.

In the case of the 5G NR standard, the radio access network 102 may be referred to as an NG-RAN, and the core network 103 may be referred to as a 5GC (5G core). In this case, the core network 103 includes an access and mobility management function (AMF), a user plane function (UPF), and a session management function (SMF). The AMF provides a function for access and mobility management in units of terminals, the UPF performs a function of mutually transmitting data units between an upper data network and the radio access network 102, and the SMF provides a session management function.

The BSs 120 may be connected to one another via Xn interface. The BS 120 may be connected to one another via core network 103 and NG interface. More specifically, the BSs 130 may be connected to an access and mobility management function (AMF) via NG-C interface, and may be connected to a user plane function (UPF) via NG-U interface.

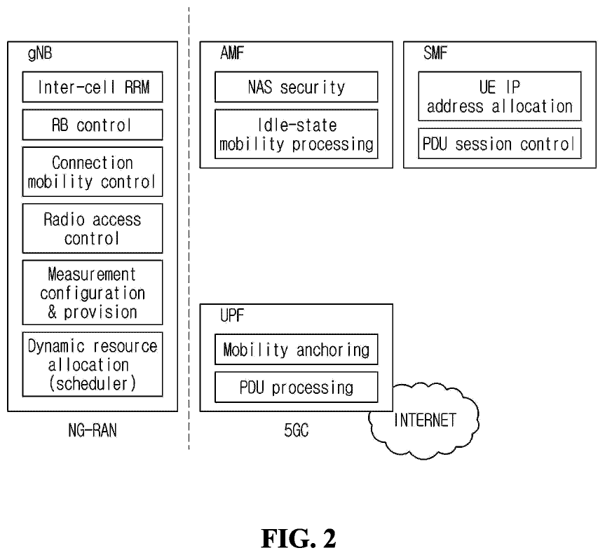

FIG. 2 illustrates a functional division between an NG-RAN and a 5GC, in accordance with an embodiment of the present disclosure. The embodiment of FIG. 2 may be combined with various embodiments of the present disclosure.

Referring to FIG. 2, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

Layers of a radio interface protocol between the UE and the network can be classified into a first layer (layer 1, L1), a second layer (layer 2, L2), and a third layer (layer 3, L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer enable to exchange an RRC message between the UE and the BS.

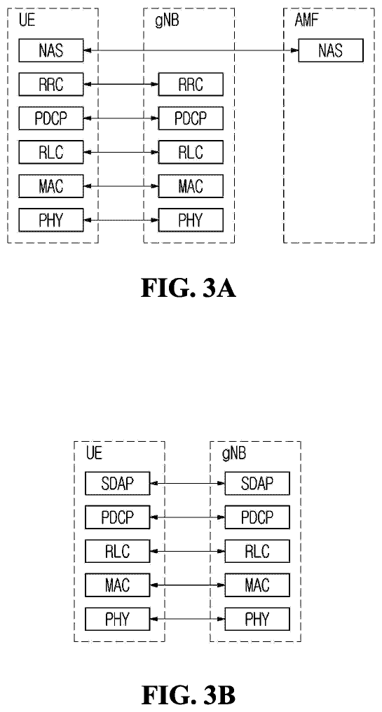

FIGS. 3A and 3B illustrate a radio protocol architecture, in accordance with an embodiment of the present disclosure. The embodiment of FIG. 3 may be combined with various embodiments of the present disclosure. Specifically, FIG. 3A exemplifies a radio protocol architecture for a user plane, and FIG. 3B exemplifies a radio protocol architecture for a control plane. The user plane corresponds to a protocol stack for user data transmission, and the control plane corresponds to a protocol stack for control signal transmission.

Referring to FIGS. 3A and 3B, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., the MAC layer, the RLC layer, and the packet data convergence protocol (PDCP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several sub-carriers in a frequency domain. One sub-frame includes a plurality of OFDM symbols in the time domain. A resource block is a unit of resource allocation, and consists of a plurality of OFDM symbols and a plurality of sub-carriers. Further, each subframe may use specific sub-carriers of specific OFDM symbols (e.g., a first OFDM symbol) of a corresponding subframe for a physical downlink control channel (PDCCH), i.e., an L1/L2 control channel. A transmission time interval (TTI) is a unit time of subframe transmission.

Radio Resource Structure

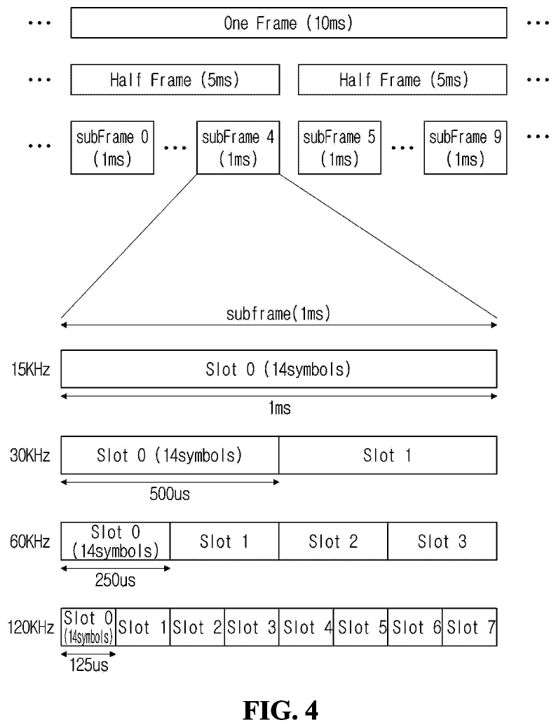

FIG. 4 illustrates a structure of a radio frame in an NR system, in accordance with an embodiment of the present disclosure. The embodiment of FIG. 4 may be combined with various embodiments of the present disclosure.

Referring to FIG. 4, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined in accordance with subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

In a case where a normal CP is used, a number of symbols per slot (N^{slot}_{symb}), a number slots per frame (N^{frame,μ}ₛₗₒₜ), and a number of slots per subframe (N^{subframe,μ}ₛₗₒₜ) may be varied based on an SCS configuration (μ). For instance, SCS (=15*2^{μ}), N^{slot}_{symb}, N^{frame,μ}ₛₗₒₜ and N^{subframe,μ}ₛₗₒₜ are 15 KHz, 14, 10 and 1, respectively, when μ=0, are 30 KHz, 14, 20 and 2, respectively, when μ=1, are 60 KHz, 14, 40 and 4, respectively, when μ=2, are 120 KHz, 14, 80 and 8, respectively, when μ=3, or are 240 KHz, 14, 160 and 16, respectively, when μ=4. Meanwhile, in a case where an extended CP is used, SCS (=15*2^{μ}), N^{slot}_{symb}, N^{frame,μ} and N^{subframe,μ} are 60 KHz, 12, 40 and 2, respectively, when μ=2.

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells. In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, frequency ranges corresponding to the FR1 and FR2 may be 450 MHz-6000 MHz and 24250 MHz-52600 MHz, respectively. Further, supportable SCSs is 15, 30 and 60 kHz for the FR1 and 60, 120, 240 kHz for the FR2. Among the frequency ranges that are used in an NR system, FR1 may mean a “sub 6 GHz range”, and FR2 may mean an “above 6 GHz range” and may also be referred to as a millimeter wave (mmW).

As described above, the values of the frequency ranges in the NR system may be changed (or varied). For example, comparing to examples for the frequency ranges described above, FR1 may be defined to include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

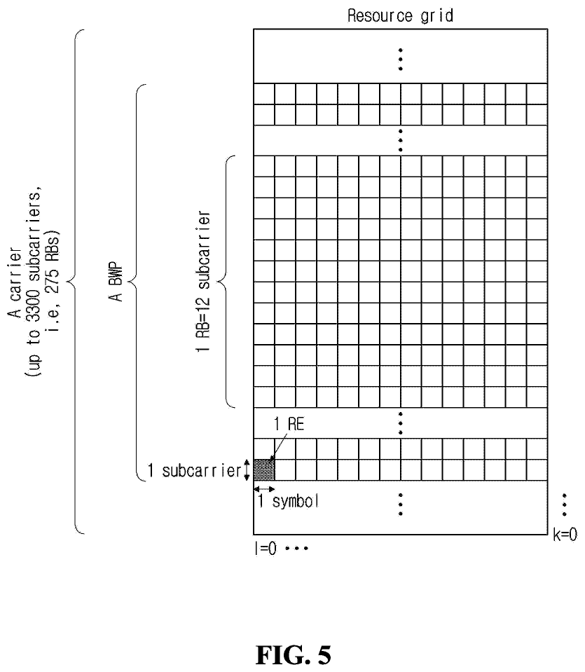

FIG. 5 illustrates a structure of a slot of an NR frame, in accordance with an embodiment of the present disclosure. The embodiment of FIG. 5 may be combined with various embodiments of the present disclosure.

Referring to FIG. 5, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Meanwhile, a radio interface between a UE and another UE or a radio interface between the UE and a network may consist of an L1 layer, an L2 layer, and an L3 layer. In various embodiments of the present disclosure, the L1 layer may imply a physical layer. In addition, for example, the L2 layer may imply at least one of a MAC layer, an RLC layer, a PDCP layer, and an SDAP layer. In addition, for example, the L3 layer may imply an RRC layer.

Bandwidth Part (BWP)

The BWP may be a set of consecutive physical resource blocks (PRBs) in a given numerology. The PRB may be selected from consecutive sub-sets of common resource blocks (CRBs) for the given numerology on a given carrier.

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a position change of the bandwidth, or a change in subcarrier spacing of the bandwidth.

For example, the bandwidth may be decreased during a period in which activity is low to save power. For example, the position of the bandwidth may move in a frequency domain. For example, the position of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be called a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, PDSCH, or CSI-RS (excluding RRM) outside the active DL BWP. For example, the UE may not trigger a channel state information (CSI) report for the inactive DL BWP. For example, the UE may not transmit a Physical Uplink Control Channel (PUCCH) or a Physical Uplink Shared Channel (PUSCH) outside an active UL BWP. For example, in a downlink case, the initial BWP may be given as a consecutive RB set for a remaining minimum system information (RMSI) control resource set (CORESET) (configured by PBCH). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

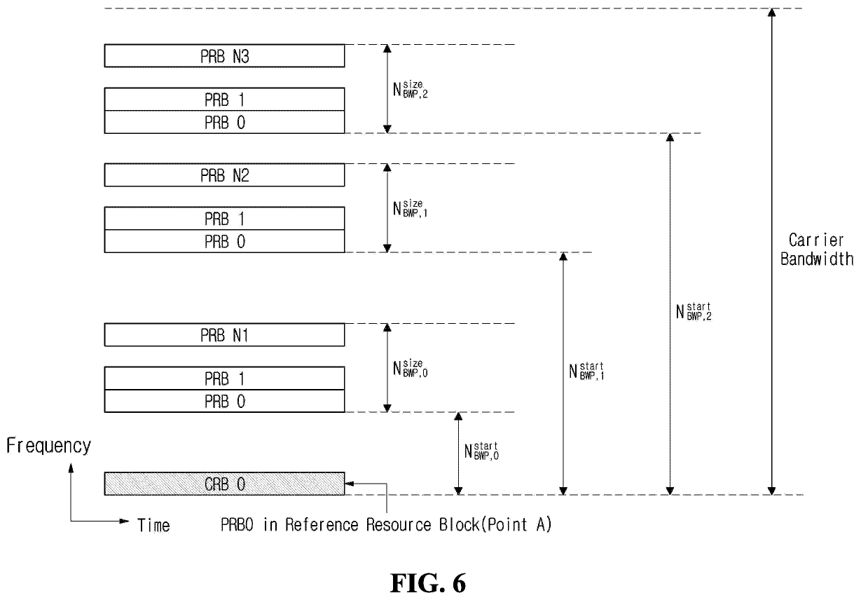

FIG. 6 illustrates an example of a BWP, in accordance with an embodiment of the present disclosure. The embodiment of FIG. 6 may be combined with various embodiments of the present disclosure. It is assumed in the embodiment of FIG. 6 that the number of BWPs is 3.

Referring to FIG. 6, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset (N^{start}_{BWP}) from the point A, and a bandwidth (N^{size}_{BWP}). For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

V2X or Sidelink Communication

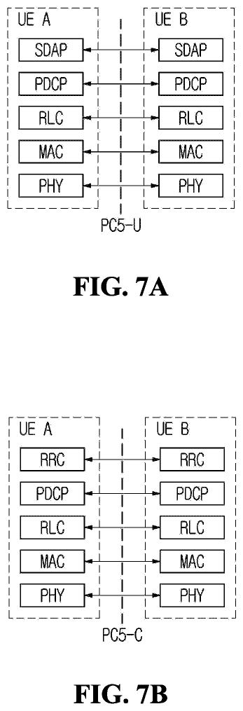

FIGS. 7A and 7B illustrate a radio protocol architecture for a SL communication, in accordance with an embodiment of the present disclosure. The embodiment of FIGS. 7A and 7B may be combined with various embodiments of the present disclosure. More specifically, FIG. 7A exemplifies a user plane protocol stack, and FIG. 7B exemplifies a control plane protocol stack.

Sidelink Synchronization Signal (SLSS) and Synchronization Information

The SLSS may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit CRC.

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-) configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

For example, based on Table 1, the UE may generate an S-SS/PSBCH block (i.e., S-SSB), and the UE may transmit the S-SS/PSBCH block (i.e., S-SSB) by mapping it on a physical resource.

TABLE 1
▪ Time-frequency structure of an S-SS/PSBCH block
In the time domain, an S-SS/PSBCH block consists of N_{symb}^{S-SSB} OFDM symbols, numbered in
increasing order from 0 to N_{symb}^{S-SSB} − 1 within the S-SS/PSBCH block, where S-PSS, S-SSS,
and PSBCH with associated DM-RS are mapped to symbols as given by Table 8.4.3.1-1.
The number of OFDM symbols in an S-SS/PSBCH block N_{symb}^{S-SSB} = 13 for normal cyclic
prefix and N_{symb}^{S-SSB} = 11 for extended cyclic prefix. The first OFDM symbol in an S-
SS/PSBCH block is the first OFDM symbol in the slot.
In the frequency domain, an S-SS/PSBCH block consists of 132 contiguous subcarriers with
the subcarriers numbered in increasing order from 0 to 131 within the sidelink S-
SS/PSBCH block. The quantities k and l represent the frequency and time indices,
respectively, within one sidelink S-SS/PSBCH block.
For an S-SS/PSBCH block, the UE shall use

| | |
|---|---|
| - | antenna port 4000 for transmission of S-PSS, S-SSS, PSBCH and DM-RS for PSBCH; |
| - | the same cyclic prefix length and subcarrier spacing for the S-PSS, S-SSS, PSBCH |
| | and DM-RS for PSBCH, |

Table 8.4.3.1-1: Resources within an S-SS/PSBCH block for
S-PSS, S-SSS, PSBCH, and DM-RS.

| | OFDM symbol number l | Subcarrier number k |
|---|---|---|
| | relative to the start of | relative to the start of |
| Channel or signal | an S-SS/PSBCH block | an S-SS/PSBCH block |
| S-PSS | 1, 2 | 2, 3, . . . , 127, 128 |
| S-SSS | 3, 4 | 2, 3, . . . , 127, 128 |
| Set to zero | 1, 2, 3, 4 | 0, 1, 129, 130, 131 |
| PSBCH | 0, 5, 6, . . . , N_{symb}^{S-SSB} − 1 | 0, 1, . . . , 131 |
| DM-RS for PSBCH | 0, 5, 6, . . . , N_{symb}^{S-SSB} − 1 | 0, 4, 8, . . . , 128 |

Synchronization Acquisition of SL Terminal

In TDMA and FDMA systems, accurate time and frequency synchronization is essential. Inaccurate time and frequency synchronization may lead to degradation of system performance due to inter-symbol interference (ISI) and inter-carrier interference (ICI). The same is true for V2X. For time/frequency synchronization in V2X, a sidelink synchronization signal (SLSS) may be used in the PHY layer, and master information block-sidelink-V2X (MIB-SL-V2X) may be used in the RLC layer.

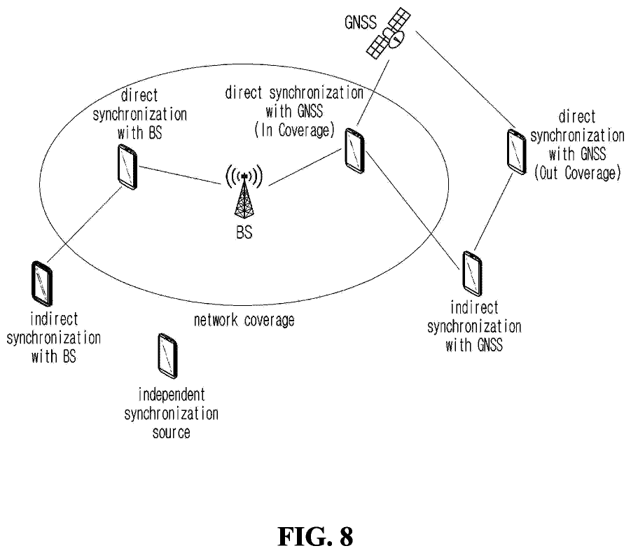

FIG. 8 illustrates a synchronization source or synchronization reference of V2X, in accordance with an embodiment of the present disclosure. The embodiment of FIG. 8 may be combined with various embodiments of the present disclosure.

Referring to FIG. 8, in V2X, a UE may be synchronized with a GNSS directly or indirectly through a UE (within or out of network coverage) directly synchronized with the GNSS. When the GNSS is configured as a synchronization source, the UE may calculate a direct subframe number (DFN) and a subframe number by using a coordinated universal time (UTC) and a (pre)determined DFN offset.

Alternatively, the UE may be synchronized with a BS directly or with another UE which has been time/frequency synchronized with the BS. For example, the BS may be an eNB or a gNB. For example, when the UE is in network coverage, the UE may receive synchronization information provided by the BS and may be directly synchronized with the BS. Thereafter, the UE may provide synchronization information to another neighboring UE. When a BS timing is set as a synchronization reference, the UE may follow a cell associated with a corresponding frequency (when within the cell coverage in the frequency), a primary cell, or a serving cell (when out of cell coverage in the frequency), for synchronization and DL measurement.

The BS (e.g., serving cell) may provide a synchronization configuration for a carrier used for V2X or SL communication. In this case, the UE may follow the synchronization configuration received from the BS. When the UE fails in detecting any cell in the carrier used for the V2X or SL communication and receiving the synchronization configuration from the serving cell, the UE may follow a predetermined synchronization configuration.

Alternatively, the UE may be synchronized with another UE which has not obtained synchronization information directly or indirectly from the BS or GNSS. A synchronization source and a preference may be preset for the UE. Alternatively, the synchronization source and the preference may be configured for the UE by a control message provided by the BS.

An SL synchronization source may be related to a synchronization priority. For example, the relationship between synchronization sources and synchronization priorities may be defined as shown in [Table 2] or [Table 3]. [Table 2] or [Table 3] is merely an example, and the relationship between synchronization sources and synchronization priorities may be defined in various manners.

TABLE 2

| Priority | | |
|---|---|---|
| Level | GNSS-based synchronization | eNB/gNB-based synchronization |
| P0 | GNSS | eNB/gNB |
| P1 | All UEs synchronized | All UEs synchronized |
| | directly with GNSS | directly with NB/gNB |
| P2 | All UEs synchronized | All UEs synchronized |
| | indirectly with GNSS | indirectly with eNB/gNB |
| P3 | All other UEs | GNSS |
| P4 | N/A | All UEs synchronized |
| | | directly with GNSS |
| P5 | N/A | All UEs synchronized |
| | | indirectly with GNSS |
| P6 | N/A | All other UEs |

TABLE 3

| Priority | | |
|---|---|---|
| Level | GNSS-based synchronization | eNB/gNB-based synchronization |
| P0 | GNSS | eNB/gNB |
| P1 | All UEs synchronized | All UEs synchronized |
| | directly with GNSS | directly with eNB/gNB |
| P2 | All UEs synchronized | All UEs synchronized |
| | indirectly with GNSS | indirectly with eNB/gNB |
| P3 | eNB/gNB | GNSS |
| P4 | All UEs synchronized | All UEs synchronized |
| | directly with eNB/gNB | directly with GNSS |
| P5 | All UEs synchronized | All UEs synchronized |
| | indirectly with eNB/gNB | indirectly with GNSS |
| P6 | Remaining UE(s) with | Remaining UE(s) with |
| | lower priority | lower priority |

In [Table 2] or [Table 3], P0 may represent a highest priority, and P6 may represent a lowest priority. In [Table 2] or [Table 3], the BS may include at least one of a gNB or an eNB.

Whether to use GNSS-based synchronization or eNB/gNB-based synchronization may be (pre)determined. In a single-carrier operation, the UE may derive its transmission timing from an available synchronization reference with the highest priority.

For example, the UE may (re)select a synchronization reference, and the UE may obtain synchronization from the synchronization reference. In addition, the UE may perform SL communication (e.g., PSCCH/PSSCH transmission/reception, physical sidelink feedback channel (PSFCH) transmission/reception, S-SSB transmission/reception, reference signal transmission/reception, etc.) based on the obtained synchronization.

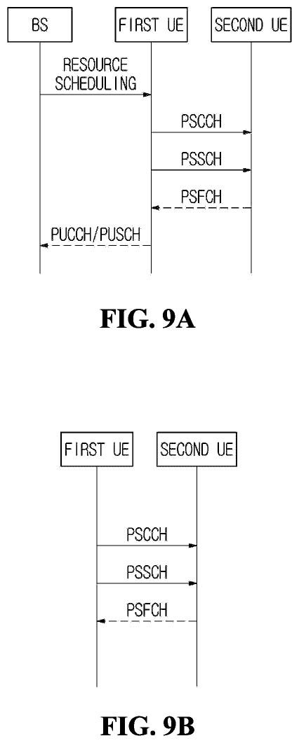

FIGS. 9A and 9B illustrate a procedure of performing V2X or SL communication by a terminal based on a transmission mode, in accordance with an embodiment of the present disclosure. The embodiment of FIGS. 9A and 9B may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, FIG. 9A exemplifies a UE operation related to an LTE transmission mode 1 or an LTE transmission mode 3. Alternatively, for example, FIG. 9B exemplifies a UE operation related to an NR resource allocation mode 1. For example, the LTE transmission mode 1 may be applied to general SL communication, and the LTE transmission mode 3 may be applied to V2X communication.

For example, FIG. 9B exemplifies a UE operation related to an LTE transmission mode 2 or an LTE transmission mode 4. Alternatively, for example, FIG. 9A exemplifies a UE operation related to an NR resource allocation mode 2.

Referring to FIG. 9A, in the LTE transmission mode 1, the LTE transmission mode 3, or the NR resource allocation mode 1, a BS may schedule an SL resource to be used by the UE for SL transmission. For example, a base station may transmit information related to SL resource(s) and/or information related to UL resource(s) to a first UE. For example, the UL resource(s) may include PUCCH resource(s) and/or PUSCH resource(s). For example, the UL resource(s) may be resource(s) for reporting SL HARQ feedback to the base station.

For example, the first UE may receive information related to dynamic grant (DG) resource(s) and/or information related to configured grant (CG) resource(s) from the base station. For example, the CG resource(s) may include CG type 1 resource(s) or CG type 2 resource(s). In the present disclosure, the DG resource(s) may be resource(s) configured/allocated by the base station to the first UE through a downlink control information (DCI). In the present disclosure, the CG resource(s) may be (periodic) resource(s) configured/allocated by the base station to the first UE through a DCI and/or an RRC message. For example, in the case of the CG type 1 resource(s), the base station may transmit an RRC message including information related to CG resource(s) to the first UE. For example, in the case of the CG type 2 resource(s), the base station may transmit an RRC message including information related to CG resource(s) to the first UE, and the base station may transmit a DCI related to activation or release of the CG resource(s) to the first UE.

Subsequently, the first UE may transmit a PSCCH (e.g., sidelink control information (SCI) or 1^{st}-stage SCI) to a second UE based on the resource scheduling. After then, the first UE may transmit a PSSCH (e.g., 2^{nd}-stage SCI, MAC PDU, data, etc.) related to the PSCCH to the second UE. After then, the first UE may receive a PSFCH related to the PSCCH/PSSCH from the second UE. For example, HARQ feedback information (e.g., NACK information or ACK information) may be received from the second UE through the PSFCH. After then, the first UE may transmit/report HARQ feedback information to the base station through the PUCCH or the PUSCH. For example, the HARQ feedback information reported to the base station may be information generated by the first UE based on the HARQ feedback information received from the second UE. For example, the HARQ feedback information reported to the base station may be information generated by the first UE based on a pre-configured rule. For example, the DCI may be a DCI for SL scheduling. For example, a format of the DCI may be a DCI format 3_0 or a DCI format 3_1. Table 4 shows an example of a DCI for SL scheduling.

TABLE 4
3GPP TS 38.212

▪ Format 3_0
DCI format 3_0 is used for scheduling of NR PSCCH and NR PSSCH in one cell.
The following information is transmitted by means of the DCI format 3_0 with CRC scrambled
by SL-RNTI or SL-CS-RNTI:

| | - | Resource pool index -[log₂ I] bits, where I is the number of resource pools for |
|---|---|---|
| | | transmission configured by the higher layer parameter sl-TxPoolScheduling. |
| | - | Time gap - 3 bits determined by higher layer parameter sl-DCI-ToSL-Trans, as |
| | | defined in clause 8.1.2.1 of [6, TS 38.214] |
| | - | HARQ process number - 4 bits as defined in clause 16.4 of [5, TS 38.213] |
| | - | New data indicator - 1 bit as defined in clause 16.4 of of [5, TS 38.213] |
| | - | Lowest index of the subchannel allocation to the initial transmission -[log₂(N_{subChannel}^{SL})] |
| | | bits as defined in clause 8.1.2.2 of [6, TS 38.214] |
| - | SCI format 1-A fields according to clause 8.3.1.1: | |
| | - | Frequency resource assignment. |
| | - | Time resource assignment. |
| - | PSFCH-to-HARQ feedback timing indicator -[log₂ N_{fb}_{_{—}}_{timing}] bits, where N_{fb}_{_{—}}_{timing} is the | |
| | number of entries in the higher layer parameter sl-PSFCH-ToPUCCH, as defined in | |
| | clause 16.5 of [5, TS 38.213] | |
| - | PUCCH resource indicator - 3 bits as defined in clause 16.5 of [5, TS 38.213]. | |
| - | Configuration index - 0 bit if the UE is not configured to monitor DCI format 3_0 with | |
| | CRC scrambled by SL-CS-RNTI: otherwise 3 bits as defined in clause 8.1.2 of [6, TS | |
| | 38.214]. If the UE is configured to monitor DCI format 3_0 with CRC scrambled by SL- | |
| | CS-RNTI, this field is reserved for DCI format 3_0 with CRC scrambled by SL-RNTI. | |
| - | Counter sidelink assignment index - 2 bits | |
| | - | 2 bits as defined in clause 16.5.2 of [5, TS 38.213] if the UE is configured with |
| | | pdsch-HARQ-ACK-Codebook = dynamic |
| | - | 2 bits as defined in clause 16.5.1 of [5, TS 38.213] if the UE is configured with |
| | | pdsch-HARQ-ACK-Codebook = semi-static |

| | |
|---|---|
| - | Padding bits, if required |

▪ Format 3_1
DCI format 3_1 is used for scheduling of LTE PSCCH and LTE PSSCH in one cell.
The following information is transmitted by means of the DCI format 3_1 with CRC scramb [symbol]
by SL-L-CS-RNTI:

| | | |
|---|---|---|
| | - | Timing offset - 3 bits determined by higher layer parameter sl-TimeOffsetEUTRA, |
| | | defined in clause 16.6 of [5, TS 38.213] |
| | - | Carrier indicator -3 bits as defined in 5.3.3.1.9A of [11, TS 36.212]. |
| | - | Lowest index of the subchannel allocation to the initial transmission - [log₂(N_{subchannel}^{SL} [symbol] |
| | | bits as defined in 5.3.3.1.9A of [11, TS 36.212]. |
| | - | Frequency resource location of initial transmission and retransmission, as defined [symbol] |
| | | 5.3.3.1.9A of [11, TS 36.212] |
| | - | Time gap between initial transmission and retransmission, as defined in 5.3.3.1.9A [symbol] |
| | | [11, TS 36.212] |
| | - | SL index - 2 bits as defined in 5.3.3.1.9A of [11, TS 36.212] |
| | - | SL SPS configuration index - 3 bits as defined in clause 5.3.3.1.9A of [11, TS 36.21 [symbol] |
| - | | Activation/release indication - 1 bit as defined in clause 5.3.3.1.9A of [11, [symbol] |

36.212]. [symbol]
indicates data missing or illegible when filed

Referring to FIG. 9B, in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannel(s). For example, subsequently, a first UE which has selected resource(s) from a resource pool by itself may transmit a PSCCH (e.g., sidelink control information (SCI) or 1st-stage SCI) to a second UE by using the resource(s). After then, the first UE may transmit a PSSCH (e.g., 2nd-stage SCI, MAC PDU, data, etc.) related to the PSCCH to the second UE. In step S8030, the first UE may receive a PSFCH related to the PSCCH/PSSCH from the second UE.

Referring to FIGS. 9A and 9B, for example, the first UE may transmit a SCI to the second UE through the PSCCH. Alternatively, for example, the first UE may transmit two consecutive SCIs (e.g., 2-stage SCI) to the second UE through the PSCCH and/or the PSSCH. In this case, the second UE may decode two consecutive SCIs (e.g., 2-stage SCI) to receive the PSSCH from the first UE. In the present disclosure, a SCI transmitted through a PSCCH may be referred to as a 1^{st} SCI, a first SCI, a 1^{st}-stage SCI or a 1^{st}-stage SCI format, and a SCI transmitted through a PSSCH may be referred to as a 2^{nd} SCI, a second SCI, a 2^{nd}-stage SCI or a 2^{nd}-stage SCI format. For example, the 1^{st}-stage SCI format may include a SCI format 1-A, and the 2^{nd}-stage SCI format may include a SCI format 2-A and/or a SCI format 2-B. Table 5 shows an example of a 1^{st}-stage SCI format.

TABLE 5
3GPP TS 38.212

```
▪ SCI format 1-A
SCI format 1-A is used for the scheduling of PSSCH and 2^{nd}-stage-SCI
on PSSCH
The following information is transmitted by means of the SCI format 1-A:
  - Priority - 3 bits as specified in clause 5.4.3.3 of [12, TS 23.287] and
  clause 5.22.1.3.1 of [8, TS 38.321].
  $‐ Frequency resource assignment ‐ [ {log}_{2} ( \frac{{N}_{subChannel}^{SL} ( {N}_{subChannel}^{SL} + 1 )}{2} ) ]$
  bits when the value of the higher layer parameter
  sl-MaxNumPerReserve is configured to 2; otherwise
  $[ {log}_{2} ( \frac{{N}_{subChannel}^{SL} ( {N}_{subChannel}^{SL} + 1 ) ( 2 {N}_{subChannel}^{SL} + 1 )}{6} ) ] bits when the$
  value of the higher layer parameter sl-MaxNumPerReserve is
  configured to 3, as defined in clause 8.1.2.2 of [6, TS 38.214].
  - Time resource assignment - 5 bits when the value of the higher layer
  parameter sl-MaxNumPerReserve is configured to 2; otherwise 9 bits
  when the value of the higher layer parameter sl-MaxNumPerReserve is
  configured to 3, as defined in clause 8.1.2.1 of [6, TS 38.214].
  - Resource reservation period -[log₂ Nᵣₛᵥ_period] bits as defined in clause
  8.1.4 of [6, TS 38.214], where Nᵣₛᵥ_period is the number of entries in the
  higher layer parameter sl-ResourceReservePeriodList, if higher layer
  parameter sl-MultiReserveResource is configured: 0 bit otherwise.
- DMRS pattern - [log₂ Nₚₐₜₜₑᵣₙ] bits as defined in clause 8.4.1.1.2 of
[4, TS 38.211], where Nₚₐₜₜₑᵣₙ is the number of DMRS patterns configured
by higher layer parameter sl-PSSCH-DMRS-TimePatternList.
- 2^{nd}-stage SCI format - 2 bits as defined in Table 8.3.1.1-1.
- Beta_offset indicator - 2 bits as provided by higher layer parameter
sl-BetaOffsets2ndSCI and Table 8.3.1.1-2.
- Number of DMRS port - 1 bit as defined in Table 8.3.1.1-3.
- Modulation and coding scheme - 5 bits as defined in clause 8.1.3 of
[6, TS 38.214].
- Additional MCS table indicator - as defined in clause 8.1.3.1 of
[6, TS 38.214]: 1 bit if one MCS table is configured by higher layer
parameter sl-Additional-MCS-Table; 2 bits if two MCS tables are
configured by higher layer parameter sl-Additional-MCS-Table; 0 bit
otherwise.
- PSFCH overhead indication - 1 bit as defined clause 8.1.3.2 of
[6, TS 38.214] if higher layer parameter sl-PSFCH-Period = 2 or 4; 0 bit
otherwise.
- Reserved - a number of bits as determined by higher layer parameter
sl-NumReservedBits, with value set to zero.
Table 8.3.1.1-1: 2^{nd}-stage SCI formats
```

| Value of 2nd-stage | |
|---|---|
| SCI format field | 2nd-stage SCI format |
| 00 | SCI format 2-A |
| 01 | SCI format 2-B |
| 10 | Reserved |
| 11 | Reserved |

Table 8.3.1.1-2: Mapping of Beta_offset
indicator values to indexes in Table 9.3-2 of [5, TS38.213]

| Value of Beta_offset | Beta_offset index in Table 9.3-2 |
|---|---|
| indicator | [5, TS38.213] |
| 00 | 1st index provided by higher layer |
| | parameter sl-BetaOffsets2ndSCI |
| 01 | 2nd index provided by higher layer |
| | parameter sl-BetaOffsets2ndSCI |
| 10 | 3rd index provided by higher layer |
| | parameter sl-BetaOffsets2ndSCI |
| 11 | 4th index provided by higher layer |
| | parameter sl-BetaOffsets2ndSCI |

Table 6 shows an example of a 2^{nd}-stage SCI format.

TABLE 6
3GPP TS 38.212

▪ SCI format 2-A
SCI format 2-A is used for the decoding of PSSCH, with HARQ operation when HARQ-ACK
information includes ACK or NACK, when HARQ-ACK information includes only NACK, or
when there is no feedback of HARQ-ACK information.
The following information is transmitted by means of the SCI format 2-A:

| | |
|---|---|
| - | HARQ process number - 4 bits as defined in clause 16.4 of [5, TS 38.213]. |
| - | New data indicator - 1 bit as defined in clause 16.4 of [5, TS 38.213]. |
| - | Redundancy version - 2 bits as defined in clause 16.4 of [6, TS 38.214]. |
| - | Source ID - 8 bits as defined in clause 8.1 of [6, TS 38.214]. |
| - | Destination ID - 16 bits as defined in clause 8.1 of [6, TS 38.214]. |
| - | HARQ feedback enabled/disabled indicator - 1 bit as defined in clause 16.3 of [5, TS |
| | 38.213]. |
| - | Cast type indicator - 2 bits as defined in Table 8.4.1.1-1. |
| - | CSI request - 1 bit as defined in clause 8.2.1 of [6, TS 38.214]. |

Table 8.4.1.1-1: Cast type indicator

| Value of Cast | |
|---|---|
| type indicator | Cast type |
| 00 | Broadcast |
| 01 | Groupcast when HARQ-ACK |
| | information includes ACK or NACK |
| 10 | Unicast |
| 11 | Groupcast when HARQ-ACK |
| | information includes only NACK |

▪ SCI format 2-B
SCI format 2-B is used for the decoding of PSSCH, with HARQ operation when HARQ-ACK
information includes only NACK, or when there is no feedback of HARQ-ACK information.
The following information is transmitted by means of the SCI format 2-B:

| | |
|---|---|
| - | HARQ process number - 4 bits as defined in clause 16.4 of [5, TS 38.213]. |
| - | New data indicator - 1 bit as defined in clause 16.4 of [5, TS 38.213]. |
| - | Redundancy version - 2 bits as defined in clause 16.4 of [6, TS 38.214]. |
| - | Source ID - 8 bits as defined in clause 8.1 of [6, TS 38.214]. |
| - | Destination ID - 16 bits as defined in clause 8.1 of [6, TS 38.214]. |
| - | HARQ feedback enabled/disabled indicator - 1 bit as defined in clause 16.3 of [5, TS |
| | 38.213]. |
| - | Zone ID - 12 bits as defined in clause 5.8.11 of [9, TS 38.331]. |
| - | Communication range requirement - 4 bits determined by higher layer parameter sl- |

ZoneConfigMCR-Index.

Referring to FIGS. 9A and 9B, the first UE may receive the PSFCH based on Table 7. For example, the first UE and the second UE may determine a PSFCH resource based on Table 7, and the second UE may transmit HARQ feedback to the first UE using the PSFCH resource.

TABLE 7

3GPP TS 38.213
▪ UE procedure for reporting HARQ-ACK on sidelink
A UE can be indicated by an SCI format scheduling a PSSCH reception, in one or more sub-
channels from a number of N_{subch}^{PSSCH} sub-channels, to transmit a PSFCH with HARQ-ACK
information in response to the PSSCH reception. The UE provides HARQ-ACK information
that includes ACK or NACK, or only NACK.
A UE can be provided, by sl-PSFCH-Period-r16, a number of slots in a resource pool for a
period of PSFCH transmission occasion resources. If the number is zero, PSFCH
transmissions from the UE in the resource pool are disabled.
A UE expects that a slot t′ₖ^{SL} (0 ≤ k < T′ₘₐₓ) has a PSFCH transmission occasion resource if
k mod N_{PSSCH}^{PSFCH} = 0, where t′ₖ^{SL} is defined in [6, TS 38.214], and T′ₘₐₓ is a number of slots that
belong to the resource pool within 10240 msec according to [6, TS 38.214], and N_{PSSCH}^{PSFCH} is
provided by sl-PSFCH-Period-r16.
A UE may be indicated by higher layers to not transmit a PSFCH in response to a PSSCH
reception [11, TS 38.321].
If a UE receives a PSSCH in a resource pool and the HARQ feedback enabled/disabled
indicator field in an associated SCI format 2-A or a SCI format 2-B has value 1 [5, TS
38.212], the UE provides the HARQ-ACK information in a PSFCH transmission in the
resource pool. The UE transmits the PSFCH in a first slot that includes PSFCH resources
and is at least a number of slots, provided by sl-MinTimeGapPSFCH-r16, of the resource
pool after a last slot of the PSSCH reception.
A UE is provided by sl-PSFCH-RB-Set-r16 a set of M_{PRB, set}^{PSFCH} PRBs in a resource pool for
PSFCH transmission in a PRB of the resource pool. For a number of N_{subch} sub-channels for
the resource pool, provided by sl-NumSubchannel, and a number of PSCCH slots associated
with a PSFCH slot that is less than or equal to N_{PSSCH}^{PSFCH}, the UE allocates the
[(i + j · N_{PSSCH}^{PSFCH}) · M_{subch, slot}^{PSFCH}, (i + 1 + j · N_{PSSCH}^{PSFCH}) · M_{subch, slot}^{PSFCH} − 1] PRBs from the M_{PRB, set}^{PSFCH} PRBs to
slot i among the PSSCH slots associated with the PSFCH slot and sub-channel j, where
M_{subch, slot}^{PSFCH} = M_{PRB, set}^{PSFCH}/(N_{subch} · N_{PSSCH}^{PSFCH}), 0 ≤ i < N_{PSSCH}^{PSFCH}, 0 ≤ j < N_{subch}, and the allocation starts
in an ascending order of i and continues in an ascending order of j. The UE expects that
M_{PRB, set}^{PSFCH} is a multiple of N_{subch} · N_{PSSCH}^{PSFCH}.
A UE determines a number of PSFCH resources available for multiplexing HARQ-ACK
information in a PSFCH transmission as R_{PRB, CS}^{PSFCH} = N_{type}^{PSFCH} · M_{subch, slot}^{PSFCH} · N_{CS}^{PSFCH} where N_{CS}^{PSFCH}
is a number of cyclic shift pairs for the resource pool and, based on an indication, by higher
layers.

| | |
|---|---|
| - | N_{type}^{PSFCH} = 1 and the M_{subch, slot}^{PSFCH} PRBs are associated with the starting sub-channel of the |
| | corresponding PSSCH |
| - | N_{type}^{PSFCH} = N_{subch}^{PSSCH} and the N_{subch}^{PSSCH} · M_{subch, slot}^{PSFCH} PRBs are associated with one or more |
| | sub-channels from the N_{subch}^{PSSCH} sub-channels of the corresponding PSSCH |

The PSFCH resources are first indexed according to an ascending order of the PRB index,
from the N_{type}^{PSFCH} · M_{subch, slot}^{PSFCH} PRBs, and then according to an ascending order of the cyclic
shift pair index from the N_{CS}^{PSFCH} cyclic shift pairs.
A UE determines an index of a PSFCH resource for a PSFCH transmission in response to a
PSSCH reception as (P_{ID} + M_{ID})modR_{PRB, CS}^{PSFCH} where P_{ID} is a physical layer source ID provided
by SCI format 2-A or 2-B [5, TS 38.212] scheduling the PSSCH reception, and M_{ID} is the
identity of the UE receiving the PSSCH as indicated by higher layers if the UE detects a SCI
format 2-A with Cast type indicator field value of “01”; otherwise, M_{ID} is zero.
A UE determines a m₀ value, for computing a value of cyclic shift α [4, TS 38.211], from a
cyclic shift pair index corresponding to a PSFCH resource index and from N_{CS}^{PSFCH} using
Table 16.3-1.
Table 16.3-1: Set of cyclic shift pairs

m₀

| | Cyclic | Cyclic | Cyclic | Cyclic | Cyclic | Cyclic |
|---|---|---|---|---|---|---|
| | Shift Pair | Shift Pair | Shift Pair | Shift Pair | Shift Pair | Shift Pair |
| N_{CS}^{PSFCH} | Index 0 | Index 1 | Index 2 | Index 3 | Index 4 | Index 5 |
| 1 | 0 | — | — | — | — | — |
| 2 | 0 | 3 | — | — | — | — |
| 3 | 0 | 2 | 4 | — | — | — |
| 6 | 0 | 1 | 2 | 3 | 4 | 5 |

A UE determines a m_{cs} value, for computing a value of cyclic shift α [4, TS 38.211], as in
Table 16.3-2 if the UE detects a SCI format 2-A with Cast type indicator field value of “01”
or “10”, or as in Table 16.3-3 if the UE detects a SCI format 2-B or a SCI format 2-A with
Cast type indicator field value of “11”. The UE applies one cyclic shift from a cyclic shift pair
to a sequence used for the PSFCH transmission [4, TS 38.211].

Table 16.3-2: Mapping of HARQ-ACK information bit values to a
cyclic shift, from a cyclic shift pair, of a sequence for a
PSFCH transmission when HARQ-ACK information includes
ACK or NACK

| HARQ-ACK Value | 0 (NACK) | 1 (ACK) |
|---|---|---|
| Sequence cyclic shift | 0 | 6 |

Table 16.3-3: Mapping of HARQ-ACK information bit values to a
cyclic shift, from a cyclic shift pair, of a sequence for a
PSFCH transmission when HARQ-ACK information includes only NACK

| HARQ-ACK Value | 0 (NACK) | 1 (ACK) |
|---|---|---|
| Sequence cyclic shift | 0 | N/A |

Referring to FIG. 9A, the first UE may transmit SL HARQ feedback to the base station through the PUCCH and/or the PUSCH based on Table 8.

TABLE 8
3GPP TS 38.213

16.5 UE procedure for reporting HARQ-ACK on uplink
A UE can be provided PUCCH resources or PUSCH resources [12, TS 38.331] to report
HARQ-ACK information that the UE generates based on HARQ-ACK information that the UE
obtains from PSFCH receptions, or from absence of PSFCH receptions. The UE reports
HARQ-ACK information on the primary cell of the PUCCH group, as described in Clause 9,
of the cell where the UE monitors PDCCH for detection of DCI format 3_0.
For SL configured grant Type 1 or Type 2 PSSCH transmissions by a UE within a time period
provided by sl-PeriodCG, the UE generates one HARQ-ACK information bit in response to
the PSFCH receptions to multiplex in a PUCCH transmission occasion that is after a last time
resource, in a set of time resources.
For PSSCH transmissions scheduled by a DCI format 3_0, a UE generates HARQ-ACK
information in response to PSFCH receptions to multiplex in a PUCCH transmission occasion
that is after a last time resource in a set of time resources provided by the DCI format 3_0.
For each PSFCH reception occasion, from a number of PSFCH reception occasions, the UE
generates HARQ-ACK information to report in a PUCCH or PUSCH transmission. The UE
can be indicated by a SCI format to perform one of the following and the UE constructs a
HARQ-ACK codeword with HARQ-ACK information, when applicable

| - | if the UE receives a PSFCH associated with a SCI format 2-A with Cast type indicator | |
|---|---|---|
| | field value of “10” | |
| | - | generate HARQ-ACK information with same value as a value of HARQ-ACK |
| | | information the UE determines from a PSFCH reception in the PSFCH reception |
| | | occasion and, if the UE determines that a PSFCH is not received at the PSFCH |
| | | reception occasion, generate NACK |
| - | if the UE receives a PSFCH associated with a SCI format 2-A with Cast type indicator | |
| | field value of “01” | |
| | - | generate ACK if the UE determines ACK from at least one PSFCH reception |
| | | occasion, from the number of PSFCH reception occasions, in PSFCH resources |
| | | corresponding to every identity M_{ID} of the UEs that the UE expects to receive the |
| | | PSSCH, as described in Clause 16.3: otherwise, generate NACK |
| - | if the UE receives a PSFCH associated with a SCI format 2-B or a SCI format 2-A with | |
| | Cast type indicator field value of “11” | |
| | - | generate ACK when the UE determines absence of PSFCH reception for each |
| | | PSFCH reception occasion from the number of PSFCH reception occasions; |
| | | otherwise, generate NACK |

After a UE transmits PSSCHs and receives PSFCHs in corresponding PSFCH resource
occasions, the priority value of HARQ-ACK information is same as the priority value of the
PSSCH transmissions that is associated with the PSFCH reception occasions providing the
HARQ-ACK information.
The UE generates a NACK when, due to prioritization, as described in Clause 16.2.4, the UE
does not receive PSFCH in any PSFCH reception occasion associated with a PSSCH
transmission in a resource provided by a DCI format 3_0 with CRC scrambled by a SL-RNTI
or, for a configured grant, in a resource provided in a single period and for which the UE is
provided a PUCCH resource to report HARQ-ACK information. The priority value of the
NACK is same as the priority value of the PSSCH transmission.
The UE generates a NACK when, due to prioritization as described in Clause 16.2.4, the UE
does not transmit a PSSCH in any of the resources provided by a DCI format 3_0 with CRC
scrambled by SL-RNTI or, for a configured grant, in any of the resources provided in a single
period and for which the UE is provided a PUCCH resource to report HARQ-ACK information.
The priority value of the NACK is same as the priority value of the PSSCH that was not
transmitted due to prioritization.
The UE generates an ACK if the UE does not transmit a PSCCH with a SCI format 1-A
scheduling a PSSCH in any of the resources provided by a configured grant in a single period
and for which the UE is provided a PUCCH resource to report HARQ-ACK information. The
priority value of the ACK is same as the largest priority value among the possible priority
values for the configured grant.
A UE does not expect to be provided PUCCH resources or PUSCH resources to report
HARQ-ACK information that start earlier than (N + 1) · (2048 + 144) · κ · 2^{μ} · T_{c} after the end
of a last symbol of a last PSFCH reception occasion, from a number of PSFCH reception
occasions that the UE generates HARQ-ACK information to report in a PUCCH or PUSCH
transmission, where

| | |
|---|---|
| - | κ and T_{c} are defined in [4, TS 38.211] |
| - | μ = min where (μ_{SL}, μ_{UL}), where μ_{SL} is the SCS configuration of the SL BWP and μ_{UL} is the SCS |
| | configuration of the active UL BWP on the primary cell |
| - | N is determined from μ according to Table 16.5-1 |

Table 16.5-1: Values of N

| μ | N |
|---|---|
| 0 | 14 |
| 1 | 18 |
| 2 | 28 |
| 3 | 32 |

With reference to slots for PUCCH transmissions and for a number of PSFCH reception
occasions ending in slot n, the UE provides the generated HARQ-ACK information in a
PUCCH transmission within slot n + k, subject to the overlapping conditions in Clause 9.2.5,
where k is a number of slots indicated by a PSFCH-to-HARQ_feedback timing indicator
field, if present, in a DCI format indicating a slot for PUCCH transmission to report the HARQ-
ACK information, or k is provided by sl-PSFCH-ToPUCCH-CG-Type1-r16, k = 0
corresponds to a last slot for a PUCCH transmission that would overlap with the last PSFCH
reception occasion assuming that the start of the sidelink frame is same as the start of the
downlink frame [4, TS 38.211].
For a PSSCH transmission by a UE that is scheduled by a DCI format, or for a SL configured
grant Type 2 PSSCH transmission activated by a DCI format, the DCI format indicates to the
UE that a PUCCH resource is not provided when a value of the PUCCH resource indicator
field is zero and a value of PSFCH-to-HARQ feedback timing indicator field, if present, is
zero. For a SL configured grant Type 1 PSSCH transmission, a PUCCH resource can be
provided by sl-N [symbol] PUCCH-AN-r16 and sl-PSFCH-ToPUCCH-CG-Type1-r16. If a PUCCH
resource is not provided, the UE does not transmit a PUCCH with generated HARQ-ACK
information from PSFCH reception occasions.
For a PUCCH transmission with HARQ-ACK information, a UE determines a PUCCH resource
after determining a set of PUCCH resources for O [symbol] HARQ-ACK information bits, as
described in Clause 9.2.1. The PUCCH resource determination is based on a PUCCH resource
indicator field [5, TS 38.212] in a last DCI format 3_0, among the DCI formats 3_0 that have
a value of a PSFCH-to-HARQ_feedback timing indicator field indicating a same slot for the
PUCCH transmission, that the UE detects and for which the UE transmits corresponding
HARQ-ACK information in the PUCCH where, for PUCCH resource determination, detected
DCI formats are indexed in an ascending order across PDCCH monitoring occasion indexes.
A UE does not expect to multiplex HARQ-ACK information for more than one SL configured
grants in a same PUCCH.
A priority value of a PUCCH transmission with one or more sidelink HARQ-ACK information
bits is the smallest priority value for the one or more HARQ-ACK information bits.
In the following, the CRC for DCI format 3_0 is scrambled with a SL-RNTI or a SL-CS-RNTI. [symbol]
indicates data missing or illegible when filed

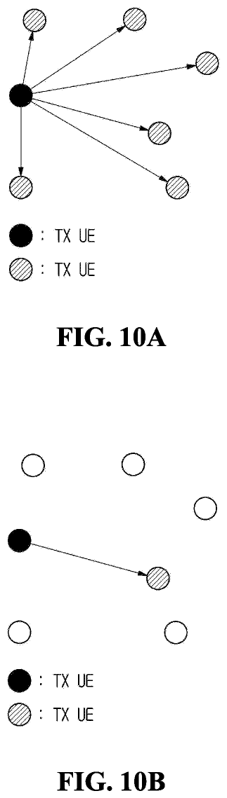

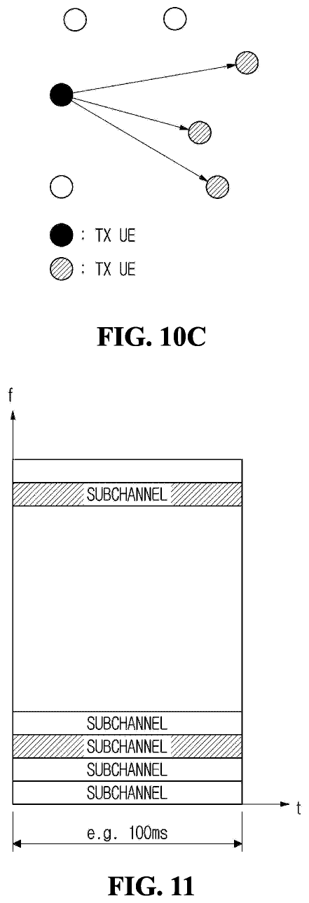

FIGS. 10A to 10C illustrate three cast types applicable to the present disclosure. The embodiment of FIGS. 10A to 10C may be combined with various embodiments of the present disclosure.

Specifically, FIG. 10A exemplifies broadcast-type SL communication, FIG. 10B exemplifies unicast type-SL communication, and FIG. 10C exemplifies groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

Hybrid Automatic Request (HARQ) Procedure

SL HARQ feedback may be enabled for unicast. In this case, in a non-code block group (non-CBG) operation, when the receiving UE decodes a PSCCH directed to it and succeeds in decoding an RB related to the PSCCH, the receiving UE may generate an HARQ-ACK and transmit the HARQ-ACK to the transmitting UE. On the other hand, after the receiving UE decodes the PSCCH directed to it and fails in decoding the TB related to the PSCCH, the receiving UE may generate an HARQ-NACK and transmit the HARQ-NACK to the transmitting UE.

For example, SL HARQ feedback may be enabled for groupcast. For example, in a non-CBG operation, two HARQ feedback options may be supported for groupcast.

(1) Groupcast option 1: When the receiving UE decodes a PSCCH directed to it and then fails to decode a TB related to the PSCCH, the receiving UE transmits an HARQ-NACK on a PSFCH to the transmitting UE. On the contrary, when the receiving UE decodes the PSCCH directed to it and then succeeds in decoding the TB related to the PSCCH, the receiving UE may not transmit an HARQ-ACK to the transmitting UE.

(2) Groupcast option 2: When the receiving UE decodes a PSCCH directed to it and then fails to decode a TB related to the PSCCH, the receiving UE transmits an HARQ-NACK on a PSFCH to the transmitting UE. On the contrary, when the receiving UE decodes the PSCCH directed to it and then succeeds in decoding the TB related to the PSCCH, the receiving UE may transmit an HARQ-ACK to the transmitting UE on the PSFCH.

For example, when groupcast option 1 is used for SL HARQ feedback, all UEs performing groupcast communication may share PSFCH resources. For example, UEs belonging to the same group may transmit HARQ feedbacks in the same PSFCH resources.

For example, when groupcast option 2 is used for SL HARQ feedback, each UE performing groupcast communication may use different PSFCH resources for HARQ feedback transmission. For example, UEs belonging to the same group may transmit HARQ feedbacks in different PSFCH resources.

In the present disclosure, HARQ-ACK may be referred to as ACK, ACK information, or positive-ACK information, and HARQ-NACK may be referred to as NACK, NACK information, or negative-ACK information.

SL Measurement and Reporting

For the purpose of QoS prediction, initial transmission parameter setting, link adaptation, link management, admission control, and so on, SL measurement and reporting (e.g., an RSRP or an RSRQ) between UEs may be considered in SL. For example, the receiving UE may receive an RS from the transmitting UE and measure the channel state of the transmitting UE based on the RS. Further, the receiving UE may report CSI to the transmitting UE. SL-related measurement and reporting may include measurement and reporting of a CBR and reporting of location information. Examples of CSI for V2X include a channel quality indicator (CQI), a precoding matrix index (PMI), a rank indicator (RI), an RSRP, an RSRQ, a path gain/pathloss, an SRS resource indicator (SRI), a CSI-RS resource indicator (CRI), an interference condition, a vehicle motion, and the like. CSI reporting may be activated and deactivated depending on a configuration.

For example, the transmitting UE may transmit a channel state information-reference signal (CSI-RS) to the receiving UE, and the receiving UE may measure a CQI or RI using the CSI-RS. For example, the CSI-RS may be referred to as an SL CSI-RS. For example, the CSI-RS may be confined to PSSCH transmission. For example, the transmitting UE may transmit the CSI-RS in PSSCH resources to the receiving UE.

Sidelink Congestion Control

For example, the UE may determine whether an energy measured in a unit time/frequency resource is equal to or greater than a predetermined level and control the amount and frequency of its transmission resources according to the ratio of unit time/frequency resources in which the energy equal to or greater than the predetermined level is observed. In the present disclosure, a ratio of time/frequency resources in which an energy equal to or greater than a predetermined level is observed may be defined as a CBR. The UE may measure a CBR for a channel/frequency. In addition, the UE may transmit the measured CBR to the network/BS.

FIG. 11 illustrates resource units for CBR measurement applicable to the present disclosure. The embodiment of FIG. 11 may be combined with various embodiments of the present disclosure.

Referring to FIG. 11, a CBR may refer to the number of subchannels of which the RS SI measurements are equal to or larger than a predetermined threshold as a result of measuring an RSSI in each subchannel during a specific period (e.g., 100 ms) by a UE. Alternatively, a CBR may refer to a ratio of subchannels having values equal to or greater than a predetermined threshold among subchannels during a specific period. For example, in the embodiment of FIG. 11, on the assumption that the hatched subchannels have values greater than or equal to a predetermined threshold, the CBR may refer to a ratio of hatched subchannels for a time period of 100 ms. In addition, the UE may report the CBR to the BS.

For example, when a PSCCH and a PSSCH are multiplexed in a frequency domain, the UE may perform one CBR measurement in one resource pool. When PSFCH resources are configured or preconfigured, the PSFCH resources may be excluded from the CBR measurement.

Further, congestion control considering a priority of traffic (e.g. packet) may be necessary. To this end, for example, the UE may measure a channel occupancy ratio (CR). Specifically, the UE may measure the CBR, and the UE may determine a maximum value CRlimitk of a channel occupancy ratio k (CRk) that can be occupied by traffic corresponding to each priority (e.g., k) based on the CBR. For example, the UE may derive the maximum value CRlimitk of the channel occupancy ratio with respect to a priority of each traffic, based on a predetermined table of CBR measurement values. For example, in case of traffic having a relatively high priority, the UE may derive a maximum value of a relatively great channel occupancy ratio. Thereafter, the UE may perform congestion control by restricting a total sum of channel occupancy ratios of traffic, of which a priority k is lower than i, to a value less than or equal to a specific value. Based on this method, the channel occupancy ratio may be more strictly restricted for traffic having a relatively low priority.

In addition thereto, the UE may perform SL congestion control by using a method of adjusting a level of transmit power, dropping a packet, determining whether retransmission is to be performed, adjusting a transmission RB size (MCS coordination), or the like.

An example of SL CBR and SL RSSI is as follows. In the description below, the slot index may be based on a physical slot index.

A SL CBR measured in slot n is defined as the portion of sub-channels in the resource pool whose SL RSSI measured by the UE exceed a (pre-)configured threshold sensed over a CBR measurement window [n−a, n−1]. Herein, a is equal to 100 or 100·2^{μ} slots, according to higher layer parameter sl-TimeWindowSizeCBR. The SL CBR is applicable for RRC_IDLE intra-frequency, RRC_IDLE inter-frequency, RRC_CONNECTED intra-frequency, or RRC_CONNECTED inter-frequency

A SL RSSI is defined as the linear average of the total received power (in [W]) observed in the configured sub-channel in OFDM symbols of a slot configured for PSCCH and PSSCH, starting from the 2^{nd} OFDM symbol. For frequency range 1, the reference point for the SL RSSI shall be the antenna connector of the UE. For frequency range 2, SL RSSI shall be measured based on the combined signal from antenna elements corresponding to a given receiver branch. For frequency range 1 and 2, if receiver diversity is in use by the UE, the reported SL RSSI value shall not be lower than the corresponding SL RSSI of any of the individual receiver branches. The SL RSSI is applicable for RRC_IDLE intra-frequency, RRC_IDLE inter-frequency, RRC_CONNECTED intra-frequency or RRC_CONNECTED inter-frequency.

An example of an SL (Channel occupancy Ratio) is as follows. The SL CR evaluated at slot n is defined as the total number of sub-channels used for its transmissions in slots [n−a, n−1] and granted in slots [n, n+b] divided by the total number of configured sub-channels in the transmission pool over [n−a, n+b]. The SL CR is applicable for RRC_IDLE intra-frequency, RRC_IDLE inter-frequency, RRC_CONNECTED intra-frequency or RRC_CONNECTED inter-frequency. Herein, a may be a positive integer and b may be 0 or a positive integer. a and b may be determined by UE implementation with a+b+1=1000 or 1000·2^{μ} slots, according to higher layer parameter sl-TimeWindowSizeCR, b<(a+b+1)/2, and n+b shall not exceed the last transmission opportunity of the grant for the current transmission. The SL CR is evaluated for each (re)transmission. In evaluating SL CR, the UE shall assume the transmission parameter used at slot n is reused according to the existing grant(s) in slot [n+1, n+b] without packet dropping. The slot index is based on physical slot index. The SL CR can be computed per priority level. A resource is considered granted if it is a member of a selected sidelink grant as defined in TS 38.321.

Positioning

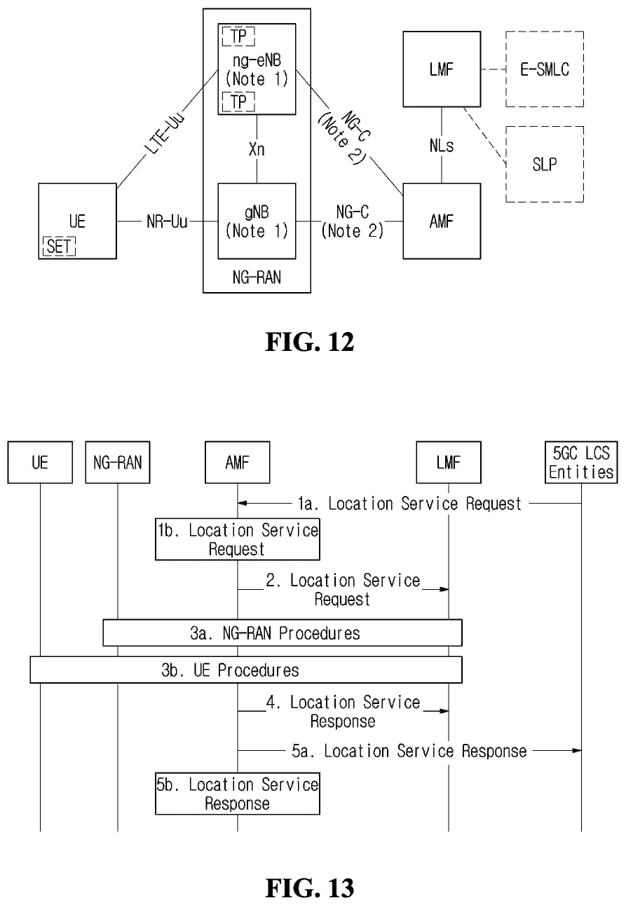

FIG. 12 illustrates an example of an architecture of a 5G system capable of positioning a UE connected to an NG-RAN or an E-UTRAN, in accordance with an embodiment of the present disclosure.

Referring to FIG. 12, an AMF may receive a request for a location service related to a specific target UE from another entity such as a gateway mobile location center (GMLC) or may autonomously determine to initiate the location service on behalf of the specific target UE. The AMF may then transmit a location service request to a location management function (LMF). Upon receipt of the location service request, the LMF may process the location service request and return a processing result including information about an estimated location of the UE to the AMF. On the other hand, when the location service request is received from another entity such as the GMLC, the AMF may deliver the processing result received from the LMF to the other entity.

A new generation evolved-NB (ng-eNB) and a gNB, which are network elements of an NG-RAN capable of providing measurement results for positioning, may measure radio signals for the target UE and transmit result values to the LMF. The ng-eNB may also control some transmission points (TPs) such as remote radio heads or positioning reference signal (PRS)-dedicated TPs supporting a PRS-based beacon system for an E-UTRA.

The LMF is connected to an enhanced serving mobile location center (E-SMLC), and the E-SMLC may enable the LMF to access an E-UTRAN. For example, the E-SMLC may enable the LMF to support observed time difference of arrival (OTDOA), which is one of positioning methods in the E-UTRAN, by using DL measurements obtained by the target UE through signals transmitted by the eNB and/or the PRS-dedicated TPs in the E-UTRAN.

The LMF may be connected to an SUPL location platform (SLP). The LMF may support and manage different location determination services for target UEs. The LMF may interact with the serving ng-eNB or serving gNB of a target UE to obtain a location measurement of the UE. For positioning the target UE, the LMF may determine a positioning method based on a location service (LCS) client type, a QoS requirement, UE positioning capabilities, gNB positioning capabilities, and ng-eNB positioning capabilities, and apply the positioning method to the serving gNB and/or the serving ng-eNB. The LMF may determine additional information such as a location estimate for the target UE and the accuracy of the position estimation and a speed. The SLP is a secure user plane location (SUPL) entity responsible for positioning through the user plane.

The UE may measure a DL signal through sources such as the NG-RAN and E-UTRAN, different global navigation satellite systems (GNSSes), a terrestrial beacon system (TBS), a wireless local area network (WLAN) access point, a Bluetooth beacon, and a UE barometric pressure sensor. The UE may include an LCS application and access the LCS application through communication with a network to which the UE is connected or through another application included in the UE. The LCS application may include a measurement and calculation function required to determine the location of the UE. For example, the UE may include an independent positioning function such as a global positioning system (GPS) and report the location of the UE independently of an NG-RAN transmission. The independently obtained positioning information may be utilized as auxiliary information of positioning information obtained from the network.

FIG. 13 illustrates exemplary implementation of a network for positioning a UE, in accordance with an embodiment of the present disclosure.

Upon receipt of a location service request when the UE is in a connection management—IDLE (CM-IDLE) state, the AMF may establish a signaling connection with the UE and request a network trigger service to assign a specific serving gNB or ng-eNB. This operation is not shown in FIG. 13. That is, FIG. 13 may be based on the assumption that the UE is in connected mode. However, the signaling connection may be released by the NG-RAN due to signaling and data deactivation during positioning.

Referring to FIG. 13, a network operation for positioning a UE will be described in detail. In step 1a, a 5GC entity such as a GMLC may request a location service for positioning a target UE to a serving AMF. However, even though the GMLC does not request the location service, the serving AMF may determine that the location service for positioning the target UE is required in step 1b. For example, for positioning the UE for an emergency call, the serving AMF may determine to perform the location service directly.

The AMF may then transmit a location service request to an LMF in step 2, and the LMF may start location procedures with the serving-eNB and the serving gNB to obtain positioning data or positioning assistance data in step 3a. Additionally, the LMF may initiate a location procedure for DL positioning with the UE in step 3b. For example, the LMF may transmit positioning assistance data (assistance data defined in 3GPP TS 36.355) to the UE, or obtain a location estimate or location measurement. Although step 3b may be additionally performed after step 3a, step 3b may be performed instead of step 3a.

In step 4, the LMF may provide a location service response to the AMF. The location service response may include information indicating whether location estimation of the UE was successful and the location estimate of the UE. Then, when the procedure of FIG. 13 is initiated in step 1a, the AMF may deliver the location service response to the 5GC entity such as the GMLC. When the procedure of FIG. 13 is initiated in step 1b, the AMF may use the location service response to provide the location service related to an emergency call or the like.

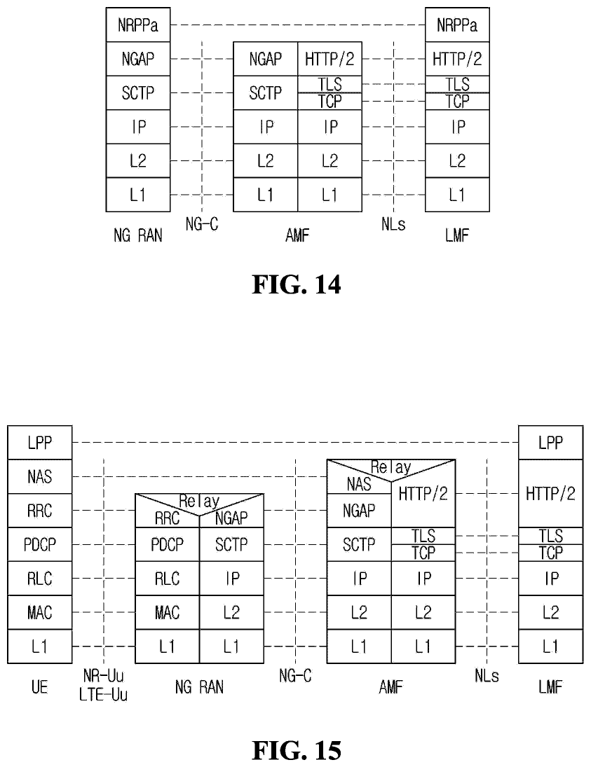

FIG. 14 illustrates exemplary protocol layers used to support LTE positioning protocol (LPP) message transmission between an LMF and a UE, in accordance with an embodiment of the present disclosure.

An LPP PDU may be transmitted in a NAS PDU between the AMF and the UE. Referring to FIG. 14, the LPP may be terminated between a target device (e.g., a UE in the control plane or a SUPL enabled terminal (SET) in the user plane) and a location server (e.g., an LMF in the control plane or an SLP in the user plane). An LPP message may be transmitted in a transparent PDU over an intermediate network interface by using an appropriate protocol such as the NG application protocol (NGAP) via an NG-control plane (NG-C) interface or a NAS/RRC via LTE-Uu and NR-Uu interfaces. The LPP allows positioning for NR and LTE in various positioning methods.

For example, the target device and the location server may exchange capability information with each other, positioning assistance data and/or location information over the LPP. Further, error information may be exchanged and/or discontinuation of an LPP procedure may be indicated, by an LPP message.

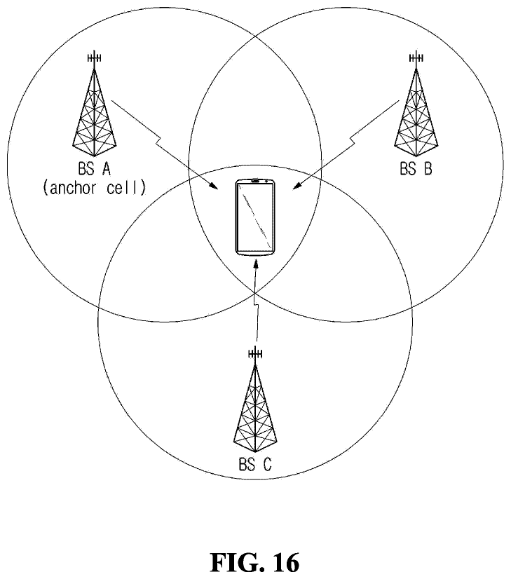

FIG. 15 illustrates exemplary protocol layers used to support NR positioning protocol A (NRPPa) PDU transmission between an LMF and an NG-RAN node, in accordance with an embodiment of the present disclosure.

NRPPa may be used for information exchange between the NG-RAN node and the LMF. Specifically, NRPPa enables exchange of an enhanced-cell ID (E-CID) for a measurement transmitted from the ng-eNB to the LMF, data to support OTDOA positioning, and a Cell-ID and Cell location ID for NR Cell ID positioning. Even without information about a related NRPPa transaction, the AMF may route NRPPa PDUs based on the routing ID of the related LMF via an NG-C interface.

Procedures of the NRPPa protocol for positioning and data collection may be divided into two types. One of the two types is a UE-associated procedure for delivering information (e.g., positioning information) about a specific UE, and the other type is a non-UE-associated procedure for delivering information (e.g., gNB/ng-eNB/TP timing information) applicable to an NG-RAN node and related TPs. The two types of procedures may be supported independently or simultaneously.

Positioning methods supported by the NG-RAN include GNSS, OTDOA, E-CID, barometric pressure sensor positioning, WLAN positioning, Bluetooth positioning, terrestrial beacon system (TBS), and UL time difference of arrival (UTDOA). Although a UE may be positioned in any of the above positioning methods, two or more positioning methods may be used to position the UE.

(1) Observed Time Difference of Arrival (OTDOA)

FIG. 16 is a diagram illustrating an OTDOA positioning method, in accordance with an embodiment of the present disclosure.

In the OTDOA positioning method, a UE utilizes measurement timings of DL signals received from multiple TPs including an eNB, ng-eNB, and a PRS-dedicated TP. The UE measures the timings of the received DL signals using positioning assistance data received from a location server. The location of the UE may be determined based on the measurement results and the geographical coordinates of neighboring TPs.

A UE connected to a gNB may request a measurement gap for OTDOA measurement from a TP. When the UE fails to identify a single frequency network (SFN) for at least one TP in OTDOA assistance data, the UE may use an autonomous gap to acquire the SFN of an OTDOA reference cell before requesting a measurement gap in which a reference signal time difference (RSTD) is measured.

Herein, an RSTD may be defined based on a smallest relative time difference between the boundaries of two subframes received from a reference cell and a measurement cell. That is, the RSTD may be calculated as a relative timing difference for between a time when the UE receives the start of a subframe from the reference cell and a time when the UE receives the start of a subframe from the measurement cell which is closest to the subframe received from the reference cell. The reference cell may be selected by the UE.

For accurate OTDOA measurement, it is necessary to measure the time of arrivals (TOAs) of signals received from three or more geographically distributed TPs or BSs. For example, TOAs for TP 1, TP 2, and TP 3 may be measured, an RSTD for TP 1-TP 2, an RSTD for TP 2-TP 3, and an RSTD for TP 3-TP 1 may be calculated based on the three TOAs, geometric hyperbolas may be determined based on the calculated RSTDs, and a point where these hyperbolas intersect may be estimated as the location of the UE. Accuracy and/or uncertainty may be involved in each TOA measurement, and thus the estimated UE location may be known as a specific range according to the measurement uncertainty.

For example, an RSTD for two TPs may be calculated by Equation 1.

$$RST Di , 1 = \frac{\text{?}}{c} - \frac{\text{?}}{c} + ( {T}_{i} - {T}_{1} ) + ( {n}_{i} - {n}_{1} ) \qquad [ Equation 1 ]$$

$$\text{?} \text{indicates text missing or illegible when filed}$$

where c is the speed of light, {xt, yt} is the (unknown) coordinates of the target UE, {xi, yi} is the coordinates of a (known) TP, and {x1, y1} is the coordinates of a reference TP (or another TP). (Ti−T1) is a transmission time offset between the two TPs, which may be referred to as “real time difference” (RTD), and ni and n1 may represent values related to UE TOA measurement errors.

(2) E-CID (Enhanced Cell ID)

In cell ID (CID) positioning, the location of a UE may be measured based on geographic information about the serving ng-eNB, serving gNB and/or serving cell of the UE. For example, the geographic information about the serving ng-eNB, the serving gNB, and/or the serving cell may be obtained by paging, registration, or the like.

For E-CID positioning, an additional UE measurement and/or NG-RAN radio resources may be used to improve a UE location estimate in addition to the CID positioning method. In the E-CID positioning method, although some of the same measurement methods as in the measurement control system of the RRC protocol may be used, an additional measurement is generally not performed only for positioning the UE. In other words, a separate measurement configuration or measurement control message may not be provided to position the UE, and the UE may also report a measured value obtained by generally available measurement methods, without expecting that an additional measurement operation only for positioning will be requested.

For example, the serving gNB may implement the E-CID positioning method using an E-UTRA measurement received from the UE.

Exemplary measurement elements that are available for E-CID positioning are given as follows.

UE measurements: E-UTRA RSRP, E-UTRA RSRQ, UE E-UTRA Rx-Tx time difference, GSM EDGE random access network (GERAN)/WLAN RSSI, UTRAN common pilot channel (CPICH) received signal code power (RSCP), and UTRAN CPICH EOM.

E-UTRAN measurements: ng-eNB Rx-Tx time difference, timing advance (TADV), and angle of arrival (AoA).

TADVs may be classified into Type 1 and Type 2 as follows.

TADV Type 1=(ng-eNB Rx-Tx time difference)+(UE E-UTRA Rx-Tx time difference)

TADV Type 2=ng-eNB Rx-Tx time difference

On the other hand, an AoA may be used to measure the direction of the UE. The AoA may be defined as an estimated angle of the UE with respect to the location of the UE counterclockwise from a BS/TP. A geographical reference direction may be North. The BS/TP may use a UL signal such as a sounding reference signal (SRS) and/or a DMRS for AoA measurement. As the arrangement of antenna arrays is larger, the measurement accuracy of the AoA is higher. When the antenna arrays are arranged at the same interval, signals received at adjacent antenna elements may have a constant phase change (phase rotation).

(3) UTDOA (UL Time Difference of Arrival)

A UTDOA is a method of determining the location of a UE by estimating the arrival time of an SRS. When the estimated SRS arrival time is calculated, a serving cell may be used as a reference cell to estimate the location of the UE based on the difference in arrival time from another cell (or BS/TP). In order to implement the UTDOA method, an E-SMLC may indicate the serving cell of a target UE to indicate SRS transmission to the target UE. Further, the E-SMLC may provide a configuration such as whether an SRS is periodic/aperiodic, a bandwidth, and frequency/group/sequence hopping.

### SPECIFIC EMBODIMENTS OF THE PRESENT DISCLOSURE

The present disclosure relates to a technique for performing positioning based on a signal from an adjacent terminal in a wireless communication system. Specifically, the present disclosure describes various embodiments in which a terminal to perform positioning requests transmission of a positioning reference signal (PRS) from an adjacent terminal and the adjacent terminal transmits the PRS.

In existing LTE and NR, a plurality of cells transmits PRSs for the purpose of UE positioning. The UE may receive PRSs from the plurality of cells, perform Reference Signal Time Difference Measurement (RSTD) with a serving cell based on the PRSs, and then find its absolute position. Positioning through PRSs improves accuracy as there are more sources (hereinafter, ‘PRS sources’) for transmitting the PRSs. Therefore, a technique for reducing interference between cells through scheduling (e.g., muting, comb, etc.) is often used so that the UE may receive PRSs from more cells. However, even if interference is reduced, if available PRS sources are insufficient or the UE is out of coverage, positioning accuracy may decrease or positioning itself may become impossible. Moreover, when a high-frequency band (e.g., millimeter wave) is used to allocate more PRSs within a frequency band, the cell coverage is significantly reduced due to path loss, blocking, etc. and thus UE positioning becomes difficult.

Accordingly, the present disclosure proposes a technique for enabling positioning by additionally securing a PRS source in a situation where PRS sources for UE positioning are insufficient. Situations in which it is necessary to secure PRS sources may be roughly classified into two situations: a first situation in which a UE is in coverage but PRS sources for positioning are insufficient and a second situation in which a UE is out of coverage. In the first situation, the UE may secure a PRS source through a method of requesting additive assistance data from a serving cell to enable the serving cell to instruct another UE, which is adjacent to the UE and knows its absolute position, to transmit a PRS or a method of directly requesting a PRS from an adjacent UE through D2D communication. In the second situation, the UE may secure a PRS source through a method of requesting assistance data from other UEs in coverage through D2D communication to directly request PRSs from other UEs or a method of requesting provision of a PRS source from a serving cell to enable the serving cell to schedule PRS transmission of another UE for a UE which is out of coverage. Through this, by using the PRS transmitted by the UE that has measured its absolute position in addition to fixed cells, a UE located in a shaded area may also perform positioning through the PRS, and positioning accuracy may increase.

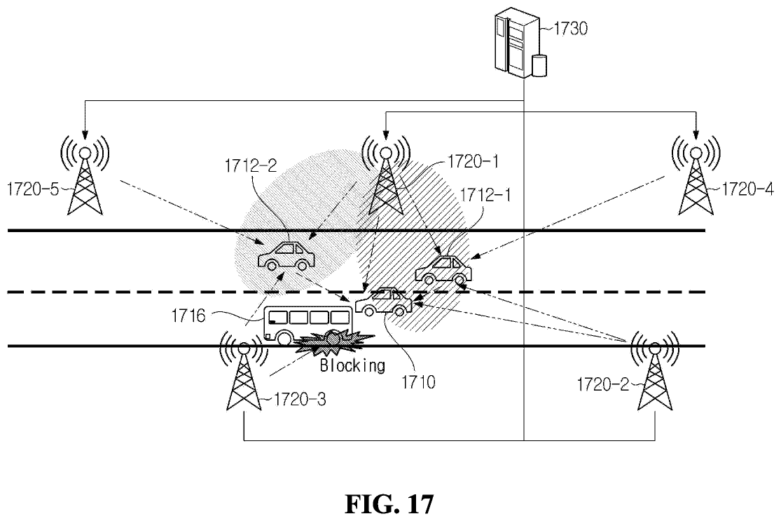

FIG. 17 illustrates a concept of a positioning technique for an in-coverage terminal according to an embodiment of the present disclosure. FIG. 17 illustrates a case where a terminal 171 performs positioning. The terminal performing positioning may be referred to as a “target device”.

Referring to FIG. 17, in the vicinity of the terminal 1710, a first RSU 1720-1, a second RSU 1720-2, a third RSU 1720-3, and a fourth RSU 1720-4 and a fifth RSU 1720-5 are present as fixed nodes, and a first adjacent terminal 1712-1 and a second adjacent terminal 1712-2 are present as mobile nodes. Here, the serving RSU of the terminal 1710 is the first RSU 1720-1.

When the terminal 1710 wants to estimate the location, a positioning server 1730 (e.g., E-SMLC) may transmit PRS information of at least one RSU to the terminal 1710 through the first RSU 1720-1. Specifically, the positioning server 1730 may provide information related to a serving RSU and a neighboring RSU, which are helpful in PRS measurement for the OTDOA operation of the terminal 1710, and PRS information of each RSU. Here, the positioning server 1730 may also be referred to as a “location server”.

In the case of FIG. 17, when considering a distance from the terminal 1710, positioning is preferably performed using the first RSU 1720-1, the second RSU 1720-2, and the third RSU 1720-3 as the PRS sources. However, since the path from the third RSU 1720-3 to the terminal 1710 is blocked by an obstacle 1716, the third RSU 1720-3 may not operate as a PRS source for positioning of the terminal 1710. Accordingly, in order to assist the positioning operation of the terminal 1710, at least one of the first adjacent terminal 1712-1 and the second adjacent terminal 1712-2 may operate as a PRS source.

The first adjacent terminal 1712-1 or the second adjacent terminal 1712-2 may operate as PRS sources under control of the first RSU 1720-1, which is the serving RSU of the terminal 1710. The first RSU 1720-1 requests PRS transmission to the terminal 1710 from the adjacent terminal 1712-1 or 1712-2 knowing its absolute position, schedules PRS transmission, and provides information on the adjacent RSUs 1720-2 and the adjacent terminal 1712-1 or 1712-2 to the terminal 1710.

Criteria for the first RSU 1720-1 to select an adjacent terminal operating as a PRS source may be defined in various ways. For example, the PRS source may be selected by one or a combination of two or more of the following conditions.

[Condition 1] another terminal having the same zone ID as the terminal 1710

[Condition 2] another terminal serviced by the same transmit (TX) beam

[Condition 3] Another terminal having the same zone ID and located within a certain distance from the first RSU 1720-1

[Condition 4] Another terminal serviced by a TX beam in a direction adjacent to a TX beam for the terminal 1710

[Condition 5] another terminal serviced by the same TX beam and located within a certain distance from the first RSU 1720-1

According to an embodiment, the conditions may be prioritized. For example, condition 1, condition 2, condition 3, condition 4, condition 5 may be applied in this order, that is, condition 1 may be applied with the highest priority and condition 5 may be applied with the lowest priority.

In the above conditions, the transmit beam is used as a means for determining the relative direction with respect to the first RSU 1720-1. However, when beamforming is not performed, for example, when operating at sub 6 GHz, a direction of arrival (DoA) measurement value of the RSU may be used instead of a transmit beam.

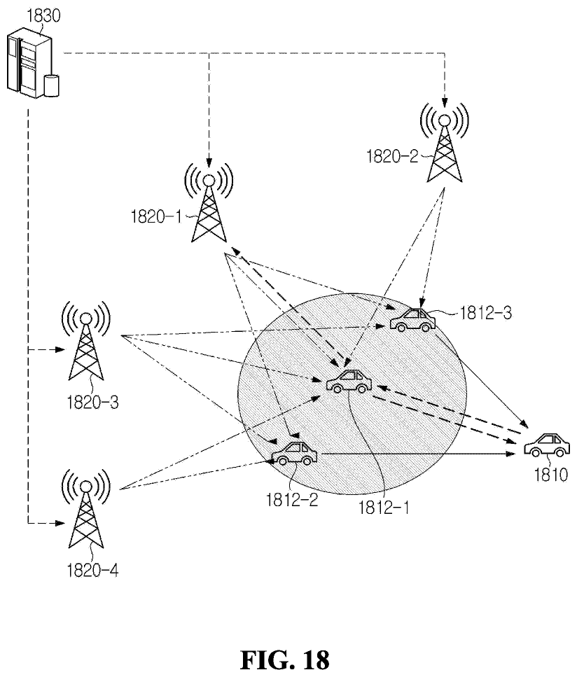

FIG. 18 illustrates a concept of a positioning technique for an out-of-coverage terminal according to an embodiment of the present disclosure. FIG. 18 illustrates a case where a terminal 1810 which is out of coverage performs positioning.

Referring to FIG. 18, a first adjacent terminal 1812-1, a second adjacent terminal 1812-2, and a third adjacent terminal 1812-3 are present in coverage. In addition, as fixed nodes capable of transmitting a signal in coverage, a first RSU 1820-1, a second RSU 1820-2, a third RSU 1820-3, and a fourth RSU 1820-4 are present. Since the terminal 1810 is out of coverage, a serving RSU for the terminal 1810 is not present, and sidelink communication with the first adjacent terminal 1812-1 may be performed.

Since the terminal 1810 is out of coverage, the RSUs 1820-1 to 1820-4 may not be used as PRS sources. Accordingly, the terminal 1810 requests assistance data for positioning from the first adjacent terminal 1812-1 connected through the sidelink. When the adjacent terminal 1812-1 knows its absolute position, the first RSU 1820-1, which is the serving RSU of the adjacent terminal 1812-1, checks at least one terminal adjacent to the first adjacent terminal 1812-1, which has received the request for the assistance data, based on the absolute positions of the adjacent terminals 1812-1 to 1812-3 in coverage, and schedules PRS transmission of the at least one checked terminal. However, when the adjacent terminal 1812-1 does not know its absolute position, the first RSU 1820-1, which is the serving RSU of the adjacent terminal 1812-1, checks at least one terminal adjacent to the adjacent terminal 1812-1 and schedules PRS transmission of the at least one checked UE, as follows.

For example, the at least one PRS source may be selected by one or a combination of two or more of the following conditions.

[Condition 1] another terminal having the same zone ID as the adjacent terminal 1812-1

[Condition 2] another terminal serviced by the same or adjacent transmit beam

[Condition 3] another terminal having the same zone ID or serviced by the same/adjacent transmit beam and located within a certain distance from the first RSU 1820-1

According to an embodiment, conditions may be prioritized. For example, condition 1, condition 2, condition 3 may be applied in this order, that is, condition 1 may be applied with the highest priority and condition 3 may be applied with the lowest priority.

Here, the transmit beam is used as a means for determining the relative direction with respect to the first RSU 1720-1. However, when beamforming is not performed, for example, when operating at sub 6 GHz, a direction of arrival (DoA) measurement value of the RSU may be used instead of a transmit beam.

As described above, for positioning of the terminal 1810, under control of the serving RSU 1820-1 of the first adjacent terminal 1812-1 connected to the terminal 1810 through a sidelink, at least one of the first adjacent terminal 1812-1, the second adjacent terminal 1812-2 or the third adjacent terminal 1812-3 may operate as a PRS source. However, according to another embodiment, the terminal 1810 may secure PRS sources by directly broadcasting a message requesting PRS transmission to other terminals existing within a neighboring discovery range.

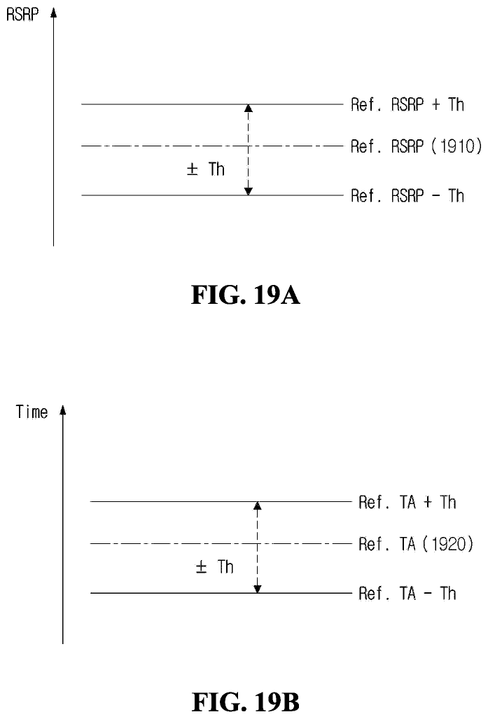

In the examples described with reference to FIGS. 17 and 18, it may be determined whether the terminal is located within a certain distance from the RSU in order to select an adjacent terminal to operate as a PRS source. Here, the certain distance means a distance from a specific terminal (e.g., the terminal 1710 of FIG. 17 and the first adjacent terminal 1812-1 of FIG. 18). Whether it is located within a certain distance from the RSU may be evaluated in various ways. For example, whether it is located within a certain distance from the RSU, as shown in FIGS. 19A and 19B below, may be evaluated based on RSRP or timing advance (TA).

FIGS. 19A and 19B illustrate examples of criteria for positioning reference signal (PRS) source selection according to an embodiment of the present disclosure. Referring to FIGS. 19A and 19B, a reference value 1910 for RSRP or a reference value 1920 for TA is set. The reference value 1910 or 1920 may be set to RSRP or TA related to an adjacent reference terminal (hereinafter referred to as a “reference terminal”) (e.g., the terminal 1710 of FIG. 17 and the first adjacent terminal 1812-1 of FIG. 18). In a case of a terminal having RSRP or TA with a difference from the reference value 1910 or 1920 less than or equal to a threshold, a distance from the RSU to the terminal may be treated as similar to a distance from the RSU to the reference terminal.

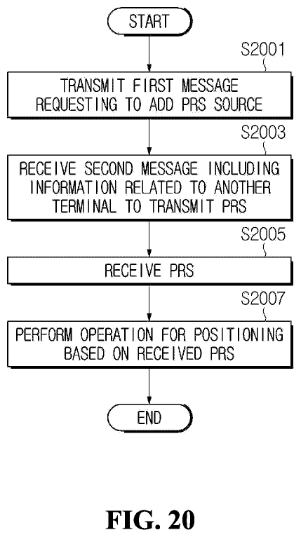

FIG. 20 illustrates an example of a method of operating a terminal requesting a PRS according to an embodiment of the present disclosure. FIG. 20 illustrates a method of operating a terminal (e.g., the terminal 1710 of FIG. 17 or the terminal 1810 of FIG. 18) that performs positioning, that is, a target device.

Referring to FIG. 20, in step S2001, the terminal transmits a first message requesting to addition of a PRS source. For example, the first message may be a message requesting assistance data for positioning. Here, the requested assistance data is additive assistance data different from an assistance server [SWH1]provided from a positioning server. According to an embodiment, the first message includes at least one of an indicator for a request to add a PRS source, the number of necessary PRS sources, a cause of determining lack of PRS sources, or information related to recently received PRSs (e.g., the number of detected PRS sources, measurement results, etc.). According to various embodiments, the request to add the PRS source may be transmitted to the RSU or a base station through a sidelink or an uplink.

In step S2003, the terminal receives a second message including information related to another terminal to transmit the PRS. According to an embodiment, the second message may include at least one of identification information of at least one other terminal to operate as a PRS source or information related to PRS transmission (e.g., bandwidth, frame or slot, muting information, antenna port, CP length, etc.). According to another embodiment, the second message may further include location information of the PRS source to be added.

In step S2005, the terminal receives at least one PRS. In other words, the terminal receives at least one PRS from at least one other terminal based on the information included in the second message. In this case, the terminal may also receive a PRS from at least one fixed node (e.g., base station, RSU) in addition to at least one other terminal. That is, the terminal may receive PRSs from a set of terminals or a set of at least one terminal and at least one fixed node. Here, the PRS from another terminal may be received according to a sidelink protocol.

In step S2007, the terminal performs an operation for positioning based on the received PRS. That is, the terminal performs an operation for positioning based on a plurality of PRSs received from a plurality of other terminals or received from at least one other terminal and at least one fixed node. Specifically, the terminal checks a PRS reception time difference from other PRS sources based on a PRS reception time from a reference PRS source. The terminal may transmit information related to the checked reception time difference to the positioning server, or may calculate the location of the terminal based on the reception time difference values.

In the embodiment described with reference to FIG. 20, the terminal uses at least one terminal indicated by the second message received from the RSU as a PRS source. In this case, all terminals indicated by the second message are not used as PRS sources, and some terminals may be excluded. For example, if it is selected by the RSU but signal quality is below a threshold, it may not be used as a PRS source. That is, although not shown in FIG. 20, the second message includes information related to PRS source candidates, and the terminal may select at least one PRS source from among the PRS source candidates.

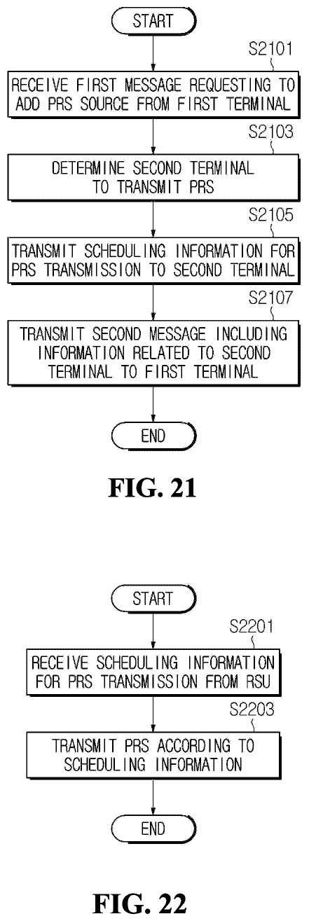

FIG. 21 illustrates an example of a method of operating a road side unit (RSU) that provides a PRS source according to an embodiment of the present disclosure. FIG. 21 illustrates a method of operating an RSU for requesting PRS transmission from a second terminal in order to assist positioning of a first terminal. Although the operating entity of FIG. 21 is described as an RSU, the operating entity may also be understood as a base station.

Referring to FIG. 21, in step S2101, the RSU receives a first message requesting addition of a PRS source from the first terminal. For example, the first message may be a message requesting assistance data for positioning. Here, the requested assistance data is additive assistance data different from an assistance server [SWH2]provided from a positioning server. According to an embodiment, the first message may include an indicator for a request to add a PRS source, the number of necessary PRS sources, a cause of determining lack of PRS sources, and information related to recently received PRSs (e.g., the number of detected PRS sources, measurement results, etc.). According to various embodiments, the request to add a PRS source may be received by the RSU through a sidelink or an uplink.

In step S2103, the RSU determines a second terminal to transmit the PRS. In other words, the RSU determines the second terminal to operate as a PRS source for positioning of the first terminal. The RSU may determine the second terminal among terminals in coverage. According to various embodiments, the RSU may select the second terminal based on at least one of location information of terminals in coverage, zone ID, transmit beam, RSRP or TA. In this case, if necessary, in addition to the second terminal, a plurality of terminals such as a third terminal and a fourth terminal may be selected as the PRS sources.

In step S2105, the RSU transmits scheduling information for PRS transmission to the second terminal. The scheduling information indicates a resource for transmitting the PRS (e.g., subframe, slot, symbol, BWP, RB, etc.) and a PRS configuration (e.g., sequence, covering code, seed value, etc.). In this case, prior to transmission of the scheduling information, the RSU may determine whether the second terminal is able to operate as a PRS source. According to an embodiment, the RSU may transmit a request message asking the second terminal whether PRS transmission is possible and receive a response message from the second terminal. If the second terminal responds that there is no PRS transmission capability, although not shown in FIG. 21, the RSU selects another terminal or ends this procedure.

In step S2107, the RSU transmits a second message including information related to the second terminal to the first terminal. According to an embodiment, the second message may include at least one of identification information of at least one other terminal to operate as a PRS source or information related to PRS transmission (e.g., bandwidth, configuration, frame or slot, muting information, antenna port, CP length, etc.). According to another embodiment, the second message may further include location information of the second terminal.

As in the embodiment described with reference to FIG. 21, the RSU determines a terminal to operate as a PRS source and performs control to transmit the PRS. In this case, the RSU selects a PRS source from among the terminals in coverage, and then inquires whether the selected terminal has PRS transmission capabilities. However, according to another embodiment, before the target device requests addition of the PRS source, the RSU inquires in advance whether other terminals have PRS transmission capabilities and manages a pool of candidate terminals able to operate as a PRS source. In this case, the inquiry target may include all terminals in coverage or terminals adjacent to the target device. Here, adjacent terminals may be selected based on criteria for determining the PRS source described in step S2103.

FIG. 22 illustrates an example of a method of operating a terminal transmitting a PRS according to an embodiment of the present disclosure. FIG. 22 illustrates a method of operating a terminal transmitting a PRS under control of an RSU.

Referring to FIG. 22, in step S2201, the terminal receives scheduling information for PRS transmission from the RSU. The scheduling information indicates a resource for transmitting the PRS (e.g., subframe, slot, symbol, BWP, RB, etc.) and a PRS configuration (e.g., sequence, covering code, seed value, etc.). In this case, prior to reception of the scheduling information, the terminal may respond to the inquiry of the RSU as to whether it is able to operate as a PRS source. According to an embodiment, the terminal may receive a request message inquiring whether PRS transmission is possible from the RSU, and may receive a response from the second terminal. If the UE responds that there is no PRS transmission capability, although not shown in FIG. 22, this procedure ends.

In step S2203, the terminal transmits a PRS according to the scheduling information. In other words, the PRS is transmitted through a resource indicated by the scheduling information. The terminal may transmit a PRS signal according to a sidelink protocol.

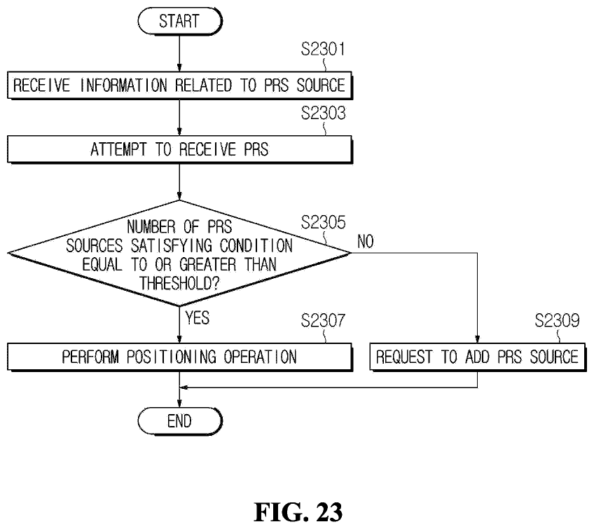

According to the embodiments described with reference to FIGS. 20, 21, and 22, a positioning operation using an adjacent terminal as a PRS source may be performed. That is, according to the above-described embodiments, the terminal may secure a PRS source necessary for positioning. In this case, the terminal determines that sufficient PRS sources are not secured only through a fixed node (e.g., RSU), and accordingly, may request addition of the PRS source. Here, a function for determining whether PRS sources are insufficient may be variously implemented. Specifically, there is a possibility that at least some of the PRSs of all PRS sources may not be received according to a channel environment in PRS information in ‘provideAssistanceData’ included in assistance information. In this case, according to the criterion implemented by the manufacturer of the device, the terminal additionally requests the PRS source. According to various embodiments, the terminal may determine whether to request addition of the PRS source based on at least one of the number of PRS sources or a measurement result of the PRS transmitted by the PRS source. The procedure for determining whether to request addition of the PRS source is shown in FIG. 23 below.

FIG. 23 illustrates an example of a method of operating a terminal for determining whether to request addition of a PRS source, according to an embodiment of the present disclosure. FIG. 22 [SWH3]illustrates a method of operating a terminal to perform positioning.

Referring to FIG. 23, in step S2301, the terminal receives information related to the PRS source. The information related to the PRS source includes information on a plurality of RSUs to transmit PRSs. Specifically, the information related to the PRS source may include information related to a resource allocated for the PRS.

In step S2303, the terminal attempts to receive PRSs. In this case, depending on the channel environment, PRSs from all or some of the PRS sources indicated by the information related to the PRS source may be detected. In other words, the PRS transmitted from at least one PRS source may not be received due to channel noise, interference, obstacles, or the like.

In step S2305, the terminal determines whether the number of PRS sources satisfying the condition is greater than or equal to a threshold. In other words, the terminal determines whether the number of detected PRS sources is equal to or greater than a threshold, and whether the detected PRS sources, the number of which is greater than or equal to the threshold, satisfy a predefined measurement condition. Here, the threshold is the minimum number of PRS sources necessary for positioning. In addition, the measurement condition may be defined based on at least one of signal quality, bandwidth, or detection duration.

If the number of PRS sources satisfying the condition is greater than or equal to the threshold, in step S2307, the terminal performs a positioning operation. That is, since an additive PRS source is not necessary, the terminal performs positioning using the received PRSs. That is, the terminal calculates a time difference between PRSs from different PRS sources.

If the number of PRS sources satisfying the condition is less than the threshold, in step S2309, the UE requests addition of the PRS source. That is, the terminal transmits a message requesting addition of the PRS source to the RSU or the adjacent terminal.

According to the embodiment described with reference to FIG. 23, it may be determined whether to request addition of a PRS source. At least one of the number of detected PRS sources or whether the detected PRS sources satisfy a measurement condition may be evaluated in order to determine whether to request addition of the PRS source. Hereinafter, the technical basis for evaluating the number of PRS sources and measurement condition will be described.

When the absolute number of PRS sources for positioning through the OTDOA method is insufficient, the terminal may determine that addition of the PRS source is necessary. For example, if a PRS is received only from another neighboring RSU or a neighboring cell in addition to a serving RSU or a serving cell, since two PRS sources are secured, the terminal may determine that addition of the PRS source is necessary. For example, in the situation as shown in FIG. 17, when the terminal 1710 has obtained PRS information including five RSUs 172-1 to 1720-5 but has received the PRSs only from the first RSU 1720-1 and the second RSU 1720-2 according to the channel environment, the terminal may determine that addition of the PRS source is necessary.

The terminal may determine that addition of the PRS source is necessary based on measurement of the signal. For example, three or more PRS sources that provide PRSs with the value [dB] of signal quality (e.g., SNR, SINR, RSRP, etc.) greater than or equal to a first threshold, the bandwidth [MHz] of the signal greater than or equal to a second threshold in the frequency domain and the measurement interval [subframe] of the signal equal to or greater than a third threshold in the time domain are checked, the terminal may determine that addition of the PRS source is not necessary. That is, the above-described conditions may be applied if it is defined that the accuracy for positioning is sufficient when the above-described conditions of quality, bandwidth, and measurement interval are satisfied. In this case, if the above-described conditions are not satisfied in the actual communication environment, the terminal may request addition of a PRS source to improve positioning accuracy.

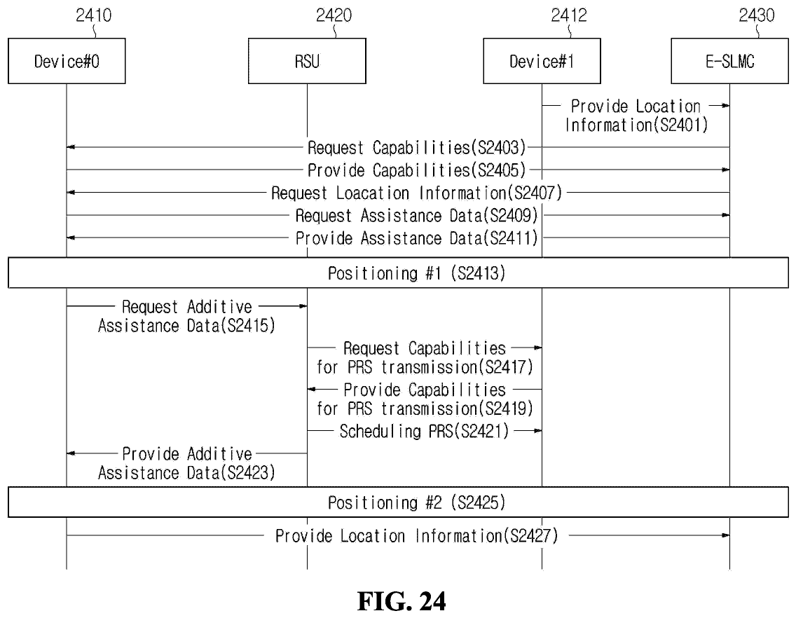

Hereinafter, examples of specific signaling procedures for performing positioning will be described with reference to FIGS. 24 to 27. Messages transmitted in the embodiments described below may be understood as an LTE positioning protocol (LPP) message or an NR positioning protocol (NRPP) message.

FIG. 24 illustrates an example of a procedure for positioning in an in-coverage case, according to an embodiment of the present disclosure. FIG. 24 illustrates signal exchange between a device #0 2410, a RSU 2420, a device #1 2412, and an E-SLMC 2430, for positioning of the device #0 2410 which is a target device. FIG. 24 illustrates an embodiment in which the device #0 2410 is in coverage of the RSU 2420 and a PRS source candidate is determined after the request of the device #0 2410.

Referring to FIG. 24, in step S2401, the device #1 2412 transmits a location information provision message to the E-SLMC 2430. For example, the location information provision message may include location information (e.g., coordinate information) or positioning-related measurement information (e.g., signal reception time difference information). Through the location information or measurement information, the E-SLMC 2430 may obtain location information of the device #1 2412.

In steps S2403 and S2403, the E-SLMC 2430 transmits a capability request message to the device #0 2410, and the device #0 2410 transmits a capability provision message to the E-SLMC 2430. Through this, the E-SLMC 2430 may determine whether the device #0 2410 is able to operate based on a positioning protocol (e.g., LPP, NRPP).

In step S2407, the E-SLMC 2430 transmits a location information request message to the device #0 2410. That is, the E-SLMC 2430 requests the device #0 2410 to perform a positioning operation or a measurement operation for positioning. The location information request message includes an indicator of the type of the requested location information. For example, the indicator may indicate OTDOA.

In steps S2409 and S2411, the device #0 2410 transmits an assistance data request message to the E-SLMC 2430, and the E-SLMC 2430 transmits an assistance data provision message to the device #0 2410. Through this, the device #0 2410 may acquire assistance data for positioning. The assistance data request message may include information indicating whether PRS assistance data is requested. The assistance data provision message may include information related to fixed nodes (e.g., the RSU 2420) operating as a PRS source and information necessary to receive PRSs from the fixed nodes.

In step S2413, the device #0 2410 performs a primary positioning operation. For example, the device #0 2410 attempts to receive PRS signals from a plurality of fixed nodes including the RSU 2420. If a sufficient number of PRSs are detected, the device #0 2410 may succeed in positioning. However, the present embodiment assumes a situation in which a sufficient number of PRSs are not detected due to channel quality degradation, obstacles, or the like. That is, the device #0 2410 fails in positioning and determines that an additive PRS source is necessary.

In step S2415, the device #0 2410 transmits an additive assistance data request message to the RSU 2420 which is the serving cell. That is, the device #0 2410 requests another terminal to operate as a PRS source. According to an embodiment, when the RSU 2420 calculates positioning of devices or stores positioning information, the additive assistance information request message is transmitted to the RSU 2420, not to the E-SLMC 2430, unlike the assistance data request message transmitted in step S2409. That is, the additive assistance data may be requested from the serving cell, not from the positioning server, and provided from the serving cell. According to another embodiment, the additive assistance request message may be transmitted to the E-SLMC 2430 through the RSU 2420 similarly to the assistance data request message transmitted in step S2409. In this case, the RSU 2420 may perform subsequent operations according to the request of the E-SLMC 2430.

In steps S2417 and S2419, the RSU 2420 transmits a PRS transmission capability request message to the device #1 2412, and the device #1 2412 transmits a PRS transmission capability provision message to the RSU 2420. That is, the RSU 2420 requests PRS transmission from the device #1 2412 by transmitting a PRS transmission capability request message. At this time, the device #1 2412 responds to the RSU 2420 that it is able to operate as a PRS source, and the RSU 2420 confirms that it is able to operate as a PRS source. The PRS transmission capability provision message is capability information related to the PRS transmission of the device #1 2412, and may include, for example, at least one of whether PRS transmission is possible or supportable configuration (e.g., bandwidth, antenna port, power, etc.).

In step S2421, the RSU 2420 transmits scheduling information related to PRS transmission to the device #1 2412. In other words, the RSU 2420 transmits, to the device #1 2412, at least one of information related to a resource for PRS transmission of the device #1 2412 or a transmission-related parameter. To this end, the RSU 2420 performs scheduling for PRS transmission of the device #1 2412. In this case, the RSU 2420 may perform scheduling based on the capability information related to PRS transmission received in step S2419.

In step S2423, the RSU 2420 transmits an additive assistance data provision message to the device #0 2410. Through this, the device #0 2410 may acquire information related to an additive PRS source. In the present embodiment, the additive assistance data provision message may include information necessary inform that the device #1 2412 will operate as a PRS source and to receive the PRS from the device #1 2412.

In step S2425, the device #0 2410 performs a secondary positioning operation. For example, the device #1 2412 transmits a PRS based on the scheduling information obtained in step S2421, and the device #0 2410 attempts to receive a PRS signal from at least one terminal including the device #1 2412. In this case, the device #0 2410 may receive the PRS signal from the at least one PRS source detected in step S2413 again. That is, the device #0 2410 performs an operation for positioning based on a plurality of PRSs received from a plurality of other terminals or received from at least one other terminal and at least one fixed node. For example, the terminal checks a reception time difference between the PRSs.

In step S2427, the device #0 2410 transmits a location information provision message to the E-SLMC 2430. For example, the location information provision message may include location information (e.g., coordinate information) or positioning-related measurement information (e.g., signal reception time difference information). Through the location information or measurement information, the E-SLMC 2430 may acquire location information of the device #0 2410.

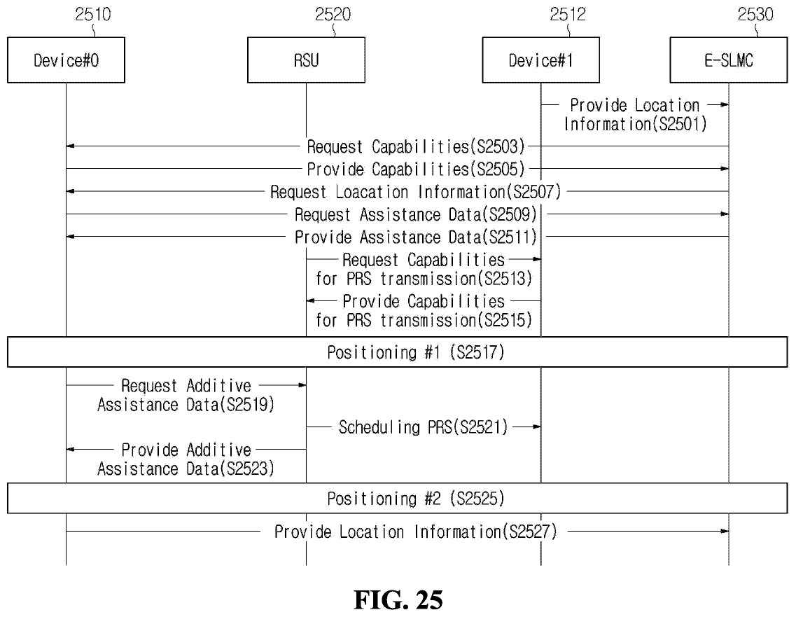

FIG. 25 illustrates another example of a procedure for positioning in an in-coverage case, according to an embodiment of the present disclosure. FIG. 25 illustrates signal exchange between a device #0 2510, a RSU 2520, a device #1 2512, and an E-SLMC 2530 for positioning of the device #0 2510 which is a target device. FIG. 25 illustrates an embodiment in which a PRS source candidate is in coverage of the RSU 2520 and a PRS source candidate is determined before the request of the device #0 2510.

Referring to FIG. 25, in step S2501, the device #1 2512 transmits a location information provision message to the E-SLMC 2530. For example, the location information provision message may include location information (e.g., coordinate information) or positioning-related measurement information (e.g., signal reception time difference information). Through the location information or measurement information, the E-SLMC 2530 may acquire location information of the device #1 2512.

In steps S2503 and S2503, the E-SLMC 2530 transmits a capability request message to the device #0 2510, and the device #0 2510 transmits a capability provision message to the E-SLMC 2530. Through this, the E-SLMC 2530 may determine whether the device #0 2510 is able to operate based on a positioning protocol (e.g., LPP, NRPP).

In step S2507, the E-SLMC 2530 transmits a location information request message to the device #0 2510. That is, the E-SLMC 2530 requests the device #0 2510 to perform a positioning operation or a measurement operation for positioning. The location information request message includes an indicator of the type of the requested location information. For example, the indicator may indicate OTDOA.

In steps S2509 and S2511, the device #0 2510 transmits an assistance data request message to the E-SLMC 2530, and the E-SLMC 2530 transmits an assistance data provision message to the device #0 2510. Through this, the device #0 2510 may acquire assistance data for positioning. The assistance data request message may include information indicating whether PRS assistance data is requested. The assistance data provision message may include information related to fixed nodes (e.g., the RSU 2520) operating as a PRS source and information necessary to receive PRSs from the fixed nodes.

In steps S2513 and S2515, the RSU 2520 transmits a PRS transmission capability request message to the device #1 2512, and the device #1 2512 transmits a PRS transmission capability provision message to the RSU 2520. At this time, the device #1 2512 responds to the RSU 2520 that it is able to operate as a PRS source, and the RSU 2520 confirms that it is able to operate as a PRS source. The PRS transmission capability provision message includes, for example, at least one of whether PRS transmission is possible or supportable configurations (e.g., bandwidth, antenna port, power, etc.) as capability information related to PRS transmission of the device #1 2512. Through this, an additive PRS source has not yet been requested by the device #0 2510, but the RSU 2520 may secure a terminal (e.g., device #1 2512) able to operate as a PRS source in order to reduce time latency.

In step S2517, the device #0 2510 performs a primary positioning operation. For example, the device #0 2510 attempts to receive PRS signals from a plurality of fixed nodes including the RSU 2520. If a sufficient number of PRSs are detected, device #0 2510 may succeed in positioning. However, the present embodiment assumes a situation in which a sufficient number of PRSs are not detected due to channel quality degradation, obstacles, or the like. That is, the device #0 2510 fails in positioning and determines that an additive PRS source is required.

In step S2519, the device #0 2510 transmits an additive assistance data request message to the RSU 2520 which is the serving cell. That is, the device #0 2510 requests another terminal to operate as a PRS source. The additive assistance information request message is transmitted to the RSU 2520, not to the E-SLMC 2530, unlike the assistance data request message transmitted in step S2509. That is, the additive assistance data is requested from the serving cell, not from the positioning server, and provided from the serving cell.

In step S2521, the RSU 2520 transmits scheduling information related to PRS transmission to the device #1 2512. In other words, the RSU 2520 transmits, to the device #1 2512, at least one of information related to a resource for PRS transmission of the device #1 2512 or a transmission-related parameter. To this end, the RSU 2520 performs scheduling for PRS transmission of the device #1 2512. In this case, the RSU 2520 may perform scheduling based on the capability information related to the PRS transmission received in step S2519.

In step S2523, the RSU 2520 transmits an additive assistance data provision message to the device #0 2510. Through this, the device #0 2510 may acquire information related to an additive PRS source. In the present embodiment, the additive assistance data provision message may include information necessary to inform that the device #1 2512 will operate as a PRS source and to receive the PRS from the device #1 2512.

In step S2525, the device #0 2510 performs a secondary positioning operation. For example, the device #1 2512 transmits a PRS based on the scheduling information obtained in step S2521, and the device #0 2510 attempts to receive a PRS signal from at least one terminal including the device #1 2512. In this case, the device #0 2510 may receive the PRS signal from the at least one PRS source detected in step S2517 again. That is, the device #0 2510 performs an operation for positioning based on a plurality of PRSs received from a plurality of other terminals or received from at least one other terminal and at least one fixed node. For example, the terminal checks a reception time difference between the PRSs.

In step S2527, the device #0 2510 transmits a location information provision message to the E-SLMC 2530. For example, the location information provision message may include location information (e.g., coordinate information) or positioning-related measurement information (e.g., signal reception time difference information). Through the location information or measurement information, the E-SLMC 2530 may acquire location information of the device #0 2510.

In the embodiment described with reference to FIG. 25, the RSU 2520 secures an additive PRS source for the device #0 2510 before the request of the device #0 2510. Thereafter, when the request of the device #0 2510 occurs, the RSU 2520 transmits scheduling information to the device #1 2512 and transmits information related to the device #1 2512 to the device #0 2510. However, during a duration between a time when the capabilities of the device #1 2512 are confirmed and a time when the scheduling information is transmitted, the device #1 2512 may not operate as a PRS source. Therefore, according to another embodiment, the RSU 2520 may transmit the scheduling information to the device #1 2512, and transmit information related to the device #1 2512 to the device #0 2510 after confirming that the device #1 2512 is able to operate as a PRS source (e.g., reception of a confirmation message for the scheduling information, etc.).

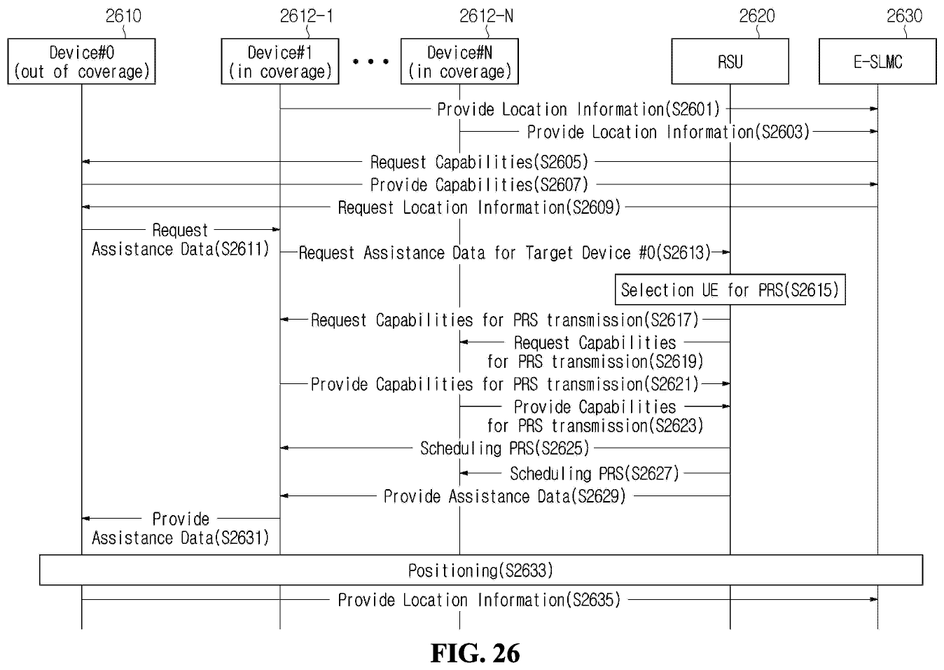

FIG. 26 illustrates an example of a procedure for positioning in an out-of-coverage case according to an embodiment of the present disclosure. FIG. 26 illustrates signal exchange between a device #0 2610, a RSU 2620, a device #1 2612-1 to a device #N 2612-N and an E-SLMC 2630, for positioning of the device #0 2610 which is a target device. FIG. 26 illustrates an embodiment in which the device #0 2610 is in [SWH4]coverage of the RSU 2620 and a PRS source candidate is determined after the request of the device #0 2610.

Referring to FIG. 26, in steps S2601 and S2603, the device #1 2612-1 to the device #N 2612-1 transmit a location information provision message to the E-SLMC 2630. For example, the location information provision message may include location information (e.g., coordinate information) or positioning-related measurement information (e.g., signal reception time difference information). Through the location information or measurement information, the E-SLMC 2630 may obtain location information of the devices #1 2612-1 to the device #N 2612-1.

In steps S2605 and S2607, the E-SLMC 2630 transmits a capability request message to the device #0 2610, and the device #0 2610 transmits a capability provision message to the E-SLMC 2630. Through this, the E-SLMC 2630 may determine whether the device #0 2610 is able to operate based on a positioning protocol (e.g., LPP, NRPP). In this case, since the device #0 2610 is out of coverage, signaling with the E-SLMC 2630 may be performed through a sidelink with the device #1 2612-1.

In step S2609, the E-SLMC 2630 transmits a location information request message to the device #0 2610. That is, the E-SLMC 2630 requests the device #0 2610 to perform a positioning operation or a measurement operation for positioning. The location information request message includes an indicator of the type of the requested location information. For example, the indicator may indicate OTDOA.

In steps S2611 and S2613, the device #0 2610 transmits an assistance data request message, and the device #1 2612-1 transmits an assistance data request message for the device #0 2610 to the RSU 2620. Since the device #0 2610 is out of coverage, the PRS from the fixed node may not be received. Accordingly, the assistance data request of the device #0 2610 is processed by the RSU 2620. For example, whether the device #0 2610 is out of coverage may be determined using an SLSS ID. That is, when the device #0 2610 includes the SLSS ID in the message instead of “physCellID” and transmits it in step S2611, the device #1 2612-1 recognizes that the device #0 2610 is out of coverage, and transmits an assistance data request message to the RSU 2620 as an end point.

In step S2615, the RSU 2620 selects PRS sources for the device #0 2610. According to an embodiment, the RSU 2620 may select all terminals that know the absolute position. Alternatively, according to another embodiment, in order to reduce consumption of resources used for signaling to operate as a PRS source, the RSU 2620 may select PRS sources based on at least one of a zone ID, a transmit beam, RSRP, or TA. In the present embodiment, the RSU 2620 selects a plurality of terminals including the device #1 2612-1 and the device #N 2612-N as PRS sources.

In steps S2617 and S2619, the RSU 2620 transmits a PRS transmission capability request message to the device #1 2612-1, and the device #1 2612-1 transmits a PRS transmission capability provision message to the RSU 2620. At this time, the device #1 2612-1 responds to the RSU 2620 that it is able to operate as a PRS source, and the RSU 2620 confirms that it is able to operate as a PRS source. The PRS transmission capability provision message may include, for example, at least one of whether PRS transmission is possible or supportable configurations (e.g., bandwidth, antenna port, power, etc.) as capability information related to PRS transmission of the device #1 2612-1. Similarly, in steps S2621 and S2623, the RSU 2620 transmits a PRS transmission capability request message to the device #N 2612-N, and the device #N 2612-N transmits the PRS transmission capability provision message to the RSU 2620.

In steps S2625 and S2627, the RSU 2620 transmits scheduling information related to PRS transmission to each of the device #1 2612-1 and the device #N 2612-N. In other words, the RSU 2620 transmits at least one of information related to a resource for PRS transmission of the device #1 2612-1 and the device #N 2612-N or a transmission-related parameter. To this end, the RSU 2620 performs scheduling for PRS transmission of the device #1 2612-1 and the device #N 2612-N. In this case, the RSU 2620 may perform scheduling based on the capability information related to PRS transmission received in steps S2619 and S2623.

In steps S2629 and S2631, the RSU 2620 transmits an assistance data provision message to the device #1 2612-1, and the device #1 2612-1 transmits an additive assistance data provision message to the device #0 2610. Through this, the device #0 2610 may acquire information related to PRS sources. In the present embodiment, the assistance data provision message may include information necessary to inform that a plurality of devices including the device #1 2612-1 and the device #N 2612-N will operate as PRS sources and to receive a PRS from the device #1 2612-1.

In step S2633, the device #0 2610 performs a positioning operation. For example, the device #1 2612-1 and the device #N 2612-N transmit PRSs based on scheduling information, and the device #0 2610 attempts to receive PRS signals from a plurality of terminals including the device #1 2612-1 and the device #N 2612-N.

In step S2634, the device #0 2610 transmits a location information provision message to the E-SLMC 2630. For example, the location information provision message may include location information (e.g., coordinate information) or positioning-related measurement information (e.g., signal reception time difference information). Through the location information or measurement information, the E-SLMC 2630 may acquire location information of the device #0 2610.

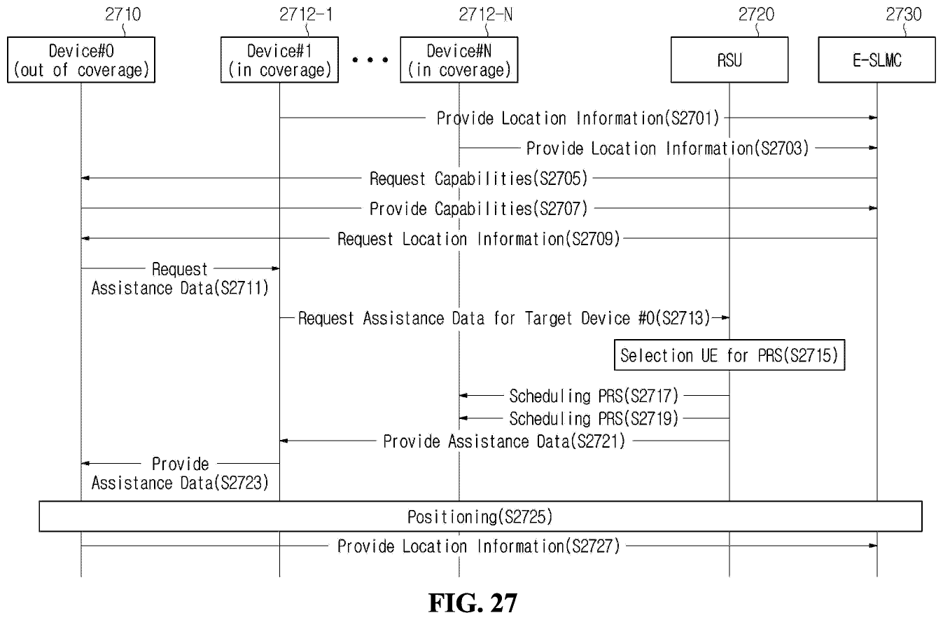

FIG. 27 illustrates another example of a procedure for positioning in an out-of-coverage case according to an embodiment of the present disclosure. FIG. 27 illustrates signal exchange between a device #0 2710, a RSU 2720, a device #1 2712-1 to a device #N 2712-N and an E-SLMC 2730, for positioning of the device #0 2710 which is a target device. FIG. 27 illustrates an embodiment in which the device #0 2710 is out of coverage of the RSU 2720 and a PRS source candidate is determined after the request of the device #0 2710.

Referring to FIG. 27, in steps S2701 and S2703, the device #1 2712-1 to the device #N 2712-1 transmit a location information provision message to the E-SLMC 2730. For example, the location information provision message may include location information (e.g., coordinate information) or positioning-related measurement information (e.g., signal reception time difference information). Through the location information or measurement information, the E-SLMC 2730 may acquire location information of the devices #1 2712-1 to the device #N 2712-1.

In steps S2705 and S2707, the E-SLMC 2730 transmits a capability request message to the device #0 2710, and the device #0 2710 transmits a capability provision message to the E-SLMC 2730. Through this, the E-SLMC 2730 may determine whether the device #0 2710 is able to operate based on a positioning protocol (e.g., LPP, NRPP).

In this case, since the device #0 2710 is out of coverage, signaling with the E-SLMC 2730 may be performed through a sidelink with the device #1 2712-1.

In step S2709, the E-SLMC 2730 transmits a location information request message to the device #0 2710. That is, the E-SLMC 2730 requests the device #0 2710 to perform a positioning operation or a measurement operation for positioning. The location information request message includes an indicator of the type of the requested location information. For example, the indicator may indicate OTDOA.

In steps S2711 and S2713, the device #0 2710 transmits an assistance data request message, and the device #1 2712-1 transmits an assistance data request message for the device #0 2710 to the RSU 2720. Since the device #0 2710 is out of coverage, the PRS from the fixed node may not be received. Accordingly, the assistance data request of the device #0 2710 is processed by the RSU 2720. For example, whether device #0 2710 is out of coverage may be determined using an SLSS ID. That is, the device #0 2710 recognizes that the device #0 2710 is out of coverage, and transmits an assistance data request message to the RSU 2720 as an end point.

In step S2715, the RSU 2720 selects PRS sources for the device #0 2710. According to an embodiment, the RSU 2720 may select all terminals that know the absolute position. Alternatively, according to another embodiment, in order to reduce consumption of resources used for signaling to operate as a PRS source, the RSU 2720 may selects PRS sources based on at least one of a zone ID, a transmit beam, RSRP, or TA. In the present embodiment, the RSU 2720 selects a plurality of terminals including the device #1 2712-1 and the device #N 2712-N as PRS sources.

In steps S2717 and S2719, the RSU 2720 transmits scheduling information related to PRS transmission to each of the device #1 2712-1 and the device #N 2712-N. In other words, the RSU 2720 transmits at least one of information related to a resource for PRS transmission of the device #1 2712-1 and the device #N 2712-N or a transmission related parameter. To this end, the RSU 2720 performs scheduling for PRS transmission of the device #1 2712-1 and the device #N 2712-N.

In steps S2721 and S2723, the RSU 2720 transmits an assistance data provision message to the device #1 2712-1, and the device #1 2712-1 transmits an additive assistance data provision message to the device #0 2710. Through this, the device #0 2710 may acquire information related to PRS sources. In the present embodiment, the assistance data provision message may include information necessary to inform that a plurality of devices including the device #1 2712-1 and the device #N 2712-N will operate as PRS sources and to receive a PRS from the device #1 2712-1.

In step S2725, the device #0 2710 performs a positioning operation. For example, the device #1 2712-1 and the device #N 2712-N transmit PRSs based on scheduling information, and the device #0 2710 attempts to receive PRS signals from a plurality of terminals including the device #1 2712-1 and the device #N 2712-N.

In step S2727, the device #0 2710 transmits a location information provision message to the E-SLMC 2730. For example, the location information provision message may include location information (e.g., coordinate information) or positioning-related measurement information (e.g., signal reception time difference information). Through the location information or measurement information, the E-SLMC 2730 may acquire location information of the device #0 2710.

According to the embodiment described with reference to FIGS. 26 and 27, the target device receives assistance data from another terminal (e.g., device #1 2612-1 or 2712-1) that is performing V2X communication in the past, receives PRSs from other terminals, and then performs positioning. Here, in the case of the embodiment described with reference to FIG. 27, unlike FIG. 26, signaling operations for checking capabilities with terminals (e.g., device #1 2712-1, device #N 2712-N) to operate as PRS sources are omitted. In this case, time latency of positioning may be further reduced. For a similar purpose, even in the embodiment described with reference to FIG. 24, signaling operations (e.g., steps S2417 and S2419) for checking capabilities with terminals to operate as PRS sources may be omitted.

According to the above-described various embodiments, positioning with high accuracy may be performed. Specifically, in order to perform positioning even in a situation where sufficient PRS sources are not secured, such as when the density of base stations is low or a target device is in a shadow area and to further increase positioning accuracy, a cooperative positioning technique for transmitting a PRS by a terminal adjacent to the target device may be provided.

In the cooperative positioning technique, PRS sources that may be used for positioning are classified into two types: a type 1 source that is a fixed node (e.g., a base station, a RSU), and a type 2 source that is a mobile node (e.g., a terminal). Since the type 1 source has a fixed position and the type 2 source has a measured position, the type 2 source has relatively low stability compared to the type 1 source. Also, the measured position values may be classified into two types, namely, a type 1 position value measured using a fixed node as a source and a type 2 position value measured using a mobile node as a source. Compared to signals and information from a fixed node that accurately knows its position, signals and information from a terminal that has derived its position through the PRS is highly likely to have a measurement error. In this case, when positioning is performed using PRSs from a plurality of PRS sources, the target device may set a priority for signals received from various sources for accuracy.

In this way, when another terminal is used as a PRS source for positioning and the second type source or second type position value is repeatedly used, in other words, the terminal which has performed its own positioning provides signals and information as a PRS source for another terminal, errors may be accumulated. Therefore, it may not be appropriate to simply determine the priority of sources only using signal quality (e.g., SNR, RSRP, RSRQ, etc.).

Accordingly, the present disclosure proposes a new parameter indicating reliability as a PRS source based on the type of the PRS source or position value. Hereinafter, the new parameter may be referred to as a reliability coefficient, a reliability indicator, an operational reliability coefficient (ORC), or the like. Hereinafter, the concept of a reliability coefficient and embodiments of improving position accuracy by contributing to reliability evaluation of a source for transmitting a signal by introducing the reliability coefficient will be described.

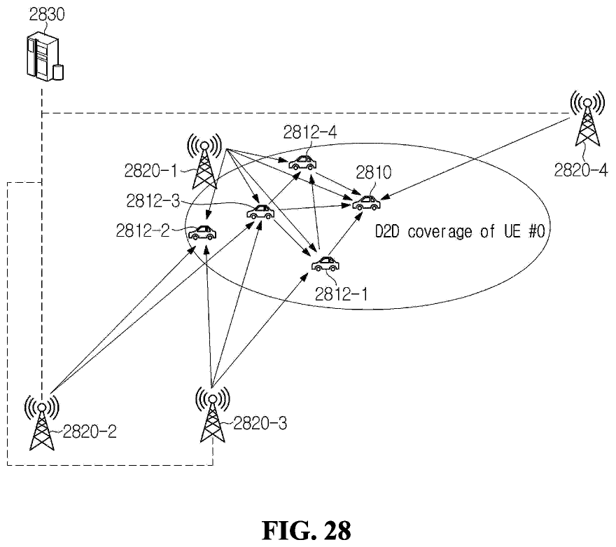

FIG. 28 illustrates a concept of reliability for a positioning value according to an embodiment of the present disclosure. Referring to FIG. 28, a terminal #1 2812-1, a terminal #2 2812-2, a terminal #3 2812-3, a terminal #4 2812-4 are in D2D coverage of a terminal #0 2810, and a first RSU 2820-1, a second RSU 2820-2, a third RSU 2820-3, and a fourth RSU 2820-4 are in the vicinity. Here, the first RSU 2820-1 is a serving cell of the terminal #0 2810.

The terminal #0 2810 may perform positioning under control of the positioning server 2830. The positioning server 2830 may store information on the RSUs 2820-1 to 2820-4, and provide information related to the serving cell and neighboring cells, which is helpful for PRS measurement for OTDOA, and PRS information of each RSU to the terminal #0 2810, which is a target device, through the first RSU 2820-1. In the case of FIG. 28, since distances from neighboring cells (e.g., the second RSU 2820-2, the fourth RSU 2820-4) included in the assistance data provided from the positioning server 2830 are long, the terminal #0 2810 may not receive PRSs from the neighboring cells with required quality. Accordingly, the terminal #0 2810 determines that the PRS is received from another adjacent vehicle terminal. The adjacent vehicle terminal is discovered by the terminal #0 2810 or determined and scheduled by the first RSU 2820-1 which is the serving cell. From the viewpoint of the terminal #0 2810, if the first RSU 2820-1 and the third RSU 2820-3 are excluded and the preference as a PRS source for adjacent terminals is determined based on signal quality, the preference is evaluated according to the relative distance in order of “first RSU 2820-1>>third RSU 2830-3>>terminal #4 2812-4>>terminal #1 2812-1>>terminal #3 2812-3”.

When a terminal is used as a PRS source for positioning and this method is repeated, errors may be accumulated. For example, the terminal #4 2812-4 used the terminal #2 2812-2 and the terminal #3 2812-3, which already have a position error during positioning, as PRS sources, and as a result, the errors overlaps. In the case of a method such as OTDOA using a reference signal, it is common that the more sources, the better accuracy. However, if the absolute position of the source is not accurate, positioning accuracy is deteriorated. Therefore, it is desirable that sources with incorrect absolute positions be excluded or have a lower priority. For this, a reliability coefficient may be applied.

When priority is given to PRS sources whose signal quality exceeds a threshold based on the terminal #0 2810, which is a target device, according to the reliability coefficient, the priority is given in order of “first RSU 2820-1>>third RSU 2820-3>>terminal #3 2812-3>>terminal #2 2812-2>>terminal #4 2812-4”. Since the RSU is a fixed node, it has a higher reliability coefficient than that of the terminal, and, since the signal quality of the first RSU 2820-1 is superior to that of the third RSU 2820-3, the first RSU 2820-1 has a first priority, and the third RSU 2820-3 has a second priority. Since PRS sources used for positioning of the terminal #3 2812-3 and the terminal #2 2812-2 are the RSUs 2820-1, 2028-2 and 2028-3 but two terminals 2812-1 and 2812-3 of the PRS sources used for positioning of the terminal #4 2812-4 are included, the terminal #4 2812-4 has a lower priority than the terminal #3 2812-3 and the terminal #2 2812-2. Since the PRS sources used for positioning of both the terminal #3 2812-3 and the terminal #2 2812-2 are RSUs (2820-1, 2028-2, 2028-3), but the terminal #2 2812-2 is relatively farther from the terminal #0 2810 than the terminal #3 2812-3, the terminal #2 2812-2 has a lower priority than the terminal #3 2812-3.

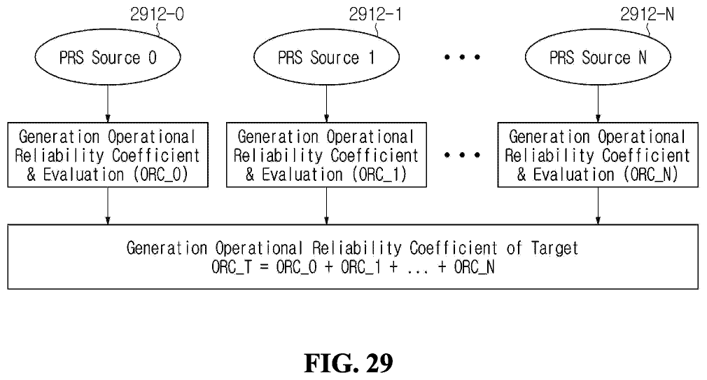

For the above result, according to an embodiment, the reliability coefficient may be determined as shown in FIG. 29 below. FIG. 29 illustrates an example of calculating a reliability coefficient for a positioning value according to an embodiment of the present disclosure. Referring to FIG. 29, N+1 PRS sources 2912-0 to 2912-N are used for positioning. Here, it is assumed that the N+1 PRS sources 2912-0 to 2912-N are sources which provide signal quality greater than or equal to a threshold and has passed a reliability test. During positioning, reliability coefficients (e.g., ORC_0 to ORC_N) of each of the PRS sources 2912-0 to 2912-N are determined by the target device. The reliability coefficient may be determined by applying values provided from the PRS sources 2912-0 to 2912-N without change or by applying a value increased by one. For example, when the PRS source is a fixed node, a provided value is used as a reliability coefficient, and, when the PRS source is a mobile node, a value greater than the provided value by 1 is used as a reliability coefficient. In addition, a sum of the reliability coefficients of the PRS sources 2912-0 to 2912-N becomes the reliability coefficient of the target terminal. In other words, if positioning is performed using all of the N+1 PRS sources 2912-0 to 2912-N, the reliability coefficient of the target device is determined as the sum of ORC_0 to ORC_N. The reliability coefficient of the target device determined as described above is provided to the terminal performing positioning when the target device is used as a PRS source. For example, the reliability coefficient may be transmitted along with PRS transmission or provided via the RSU.

According to the example of FIG. 29, in FIG. 28, the first RSU 2820-1 and the third RSU 2820-3 are fixed nodes and thus have a reliability coefficient of 0. The terminal #3 2812-3 and the terminal #2 2812-2 are mobile nodes but use only the fixed nodes as PRS sources for positioning and thus have a reliability coefficient of 0. The terminal #4 2812-4 uses two mobile nodes (e.g., the terminal #1 2812-1 and the terminal #3 2812-3) as PRS sources and thus have a reliability coefficient of 2. In this case, for example, if the terminal #0 2810 allows up to four PRS sources, up to the terminal #2 2812-2 may be used for positioning. As another example, if a rule is defined to allow up to 5 PRS sources and to exclude PRS sources with a reliability coefficient of 2 or higher, the terminal #4 2812-4 is excluded, and up to the terminal #2 2812-2 is used for positioning.

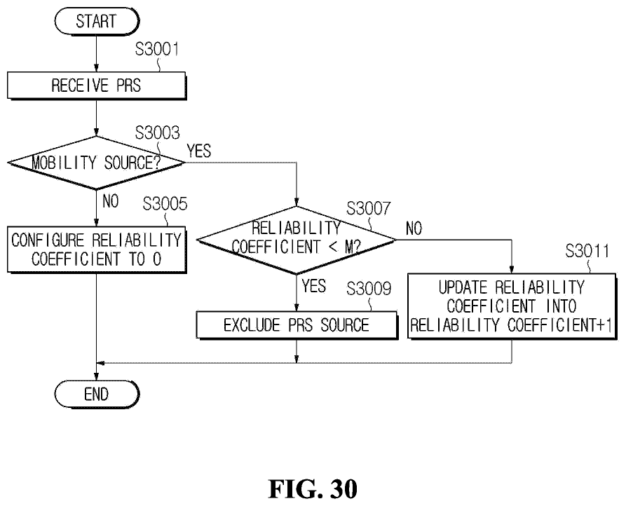

FIG. 30 illustrates an example of a method of operating a terminal for determining a reliability coefficient according to an embodiment of the present disclosure. FIG. 30 illustrates a method of operating a terminal (e.g., the terminal 1810 of FIG. 28) that performs positioning, that is, a target device. FIG. 30 illustrates an operation of determining a reliability coefficient for one PRS source, and the procedure illustrated in FIG. 30 may be repeated as many as the number of PRS sources during positioning.

Referring to FIG. 30, in step S3001, the terminal receives a PRS. In this case, according to an embodiment, a reliability coefficient of the PRS source that has transmitted the PRS may be received together with the PRS. According to another embodiment, the reliability coefficient of the PRS source may be obtained from assistance data received prior to the PRS.

In step S3003, the terminal determines whether the PRS source is a mobility source. In other words, the terminal determines whether the PRS source is a mobile node or a fixed node. The terminal may determine whether it is a mobile node or a fixed node based on whether the information on the PRS source is received from the RSU or the positioning server.

If the PRS source is not a mobile source, in step S3005, the terminal sets the reliability coefficient of the PRS source to 0. That is, since the PRS source is a fixed node, the terminal sets the reliability coefficient of the PRS source to 0 indicating that there is no accumulated error. On the other hand, if the PRS source is a mobile source, in step S3007, the terminal determines whether the reliability coefficient of the PRS source is less than M. M is a threshold of the reliability coefficient of the available PRS source.

If the reliability coefficient is greater than or equal to M, in step S3009, the terminal excludes the PRS source. In other words, the terminal determines not to use the PRS source for positioning. On the other hand, if the reliability coefficient is less than M, in step S3011, the terminal increases the reliability coefficient of the PRS source by 1.

The procedure described with reference to FIG. 30 may be performed on each PRS source. When the evaluation of each PRS source is completed, the terminal performs positioning using the PRS sources that have passed the reliability test, and determines its reliability coefficient. When the terminal is used as a PRS source for another terminal, the determined reliability coefficient may be transmitted together with the PRS. According to various embodiments, the reliability coefficient may be expressed through the PRS (e.g., used as a variable when generating a PRS sequence) or may be multiplexed with the PRS.

In the embodiment described with reference to FIG. 30, the target device performing positioning excludes a PRS source having low reliability based on the reliability coefficient. However, according to another embodiment, the PRS source having low reliability may be excluded by the PRS itself rather than the target device. For example, when the RSU asks the terminal whether it is able to operate as a PRS source (e.g., transmission of a PRS transmission capability request message), the terminal may compare its reliability coefficient with a threshold, and, if it is less than the threshold, respond that it is able to operate as a PRS source.

As described with reference to FIGS. 28 to 30, a reliability coefficient may be used to filter the PRS source. In the above-described embodiments, the terminal, which has performed the positioning, updates the reliability coefficients of the used PRS sources (e.g., increases by 1 in the case of a mobile node), and then determines its reliability coefficient. That is, the reliability coefficient provided by the PRS source is information that does not reflect whether the PRS source is a mobile node. However, according to another embodiment, instead of updating the reliability coefficients of the PRS sources by the terminal which has performed positioning, each terminal may determine the reliability coefficient based on whether it is a mobile node. In this case, the terminal, which has performed positioning using only the fixed PRS sources, will determine its reliability coefficient to be 1, and the terminal, which has performed positioning using one mobile PRS source, will determine its reliability coefficient to be 2. That is, the terminal may determine its reliability coefficient to be a value greater than the number of mobile PRS sources used for positioning by one. In this case, an operation of updating the reliability coefficient for each PRS source is not necessary in order to determine its reliability coefficient.

As described above, by introducing the reliability coefficient, a factor that lowers the positioning accuracy of the target device due to overlapping of positioning errors may be excluded. That is, by giving a priority according to a reliability coefficient and selecting a PRS source according to the priority, positioning accuracy may be improved. On the other hand, even if any PRS source has passed the signal quality test but has a reliability coefficient greater than or equal to the threshold, if the number of PRS sources for positioning is absolutely insufficient, it may be used for positioning.

System and Various Devices to which Embodiments of the Present Disclosure are Applicable

Various embodiments of the present disclosure may be combined with each other.

Hereinafter, a device to which various embodiments of the present disclosure may be applied will be described. Although not limited thereto, various descriptions, functions, procedures, proposals, methods, and/or operation flowcharts disclosed in this document may be applied to various fields requiring wireless communication/connection (e.g., 5G) between devices.

Hereinafter, it will be described in more detail with reference to the drawings. In the following drawings/description, the same reference numerals may represent the same or corresponding hardware blocks, software blocks, or functional blocks, unless otherwise indicated.

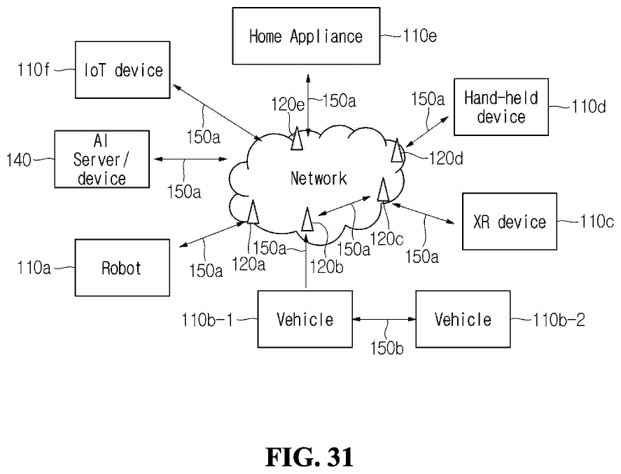

FIG. 31 illustrates a communication system, in accordance with an embodiment of the present disclosure. The embodiment of FIG. 31 may be combined with various embodiments of the present disclosure.

Referring to FIG. 31, the communication system applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include at least one of a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120a to 120e network may be implemented by a wireless device, and a specific wireless device 120a may operate as a base station/network node for another wireless device.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names

The wireless devices 100a to 100f may be connected to the network through the base station 120. AI technology is applicable to the wireless devices 100a to 100f, and the wireless devices 100a to 100f may be connected to the AI server 100g through the network. The network may be configured using a 3G network, a 4G (e.g., LTE) network or a 5G (e.g., NR) network, etc. The wireless devices 100a to 100f may communicate with each other through the base stations 120a to 120e or perform direct communication (e.g., sidelink communication) without through the base stations 120a to 120e. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base stations 120a to 120e and the base stations 120a to 120e/the base stations 120a to 120e. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

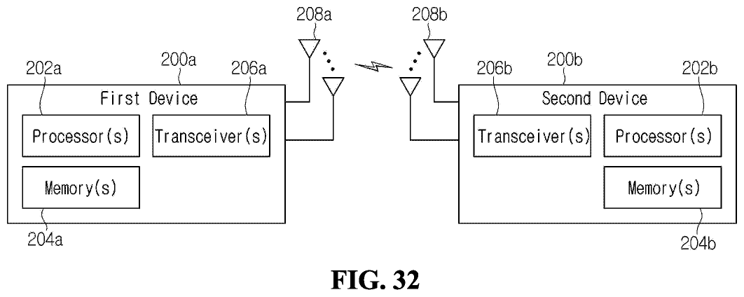

FIG. 32 illustrates wireless devices, in accordance with an embodiment of the present disclosure. The embodiment of FIG. 32 may be combined with various embodiments of the present disclosure.

Referring to FIG. 32, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 31.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may perform wireless communications with the first wireless device 200a and may include one or more processors 202b and one or more memories 204b and may further include one or more transceivers 206b and/or one or more antennas 208b. The functions of the one or more processors 202b, one or more memories 204b, one or more transceivers 206b, and/or one or more antennas 208b are similar to those of one or more processors 202a, one or more memories 204a, one or more transceivers 206a and/or one or more antennas 208a of the first wireless device 200a.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs), one or more service data unit (SDU), messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands

One or more memories 204a and 204b may be coupled with one or more processors 202a and 202b to store various types of data, signals, messages, information, programs, code, instructions and/or commands One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. In addition, one or more transceivers 206a and 206b may be coupled with one or more antennas 208a and 208b, and may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

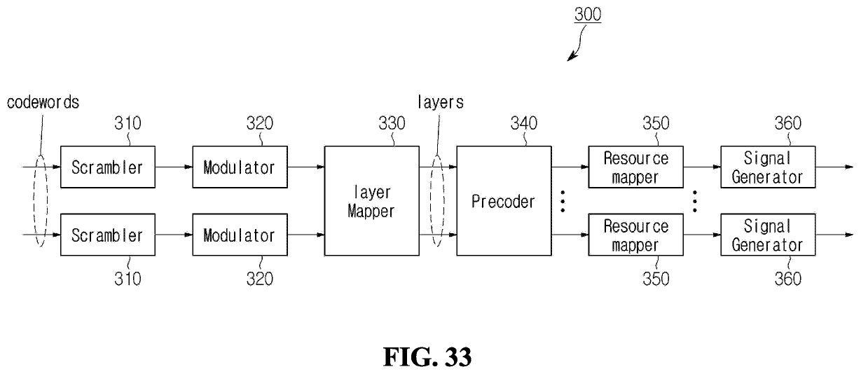

FIG. 33 illustrates a signal process circuit for a transmission signal, in accordance with an embodiment of the present disclosure. The embodiment of FIG. 33 may be combined with various embodiments of the present disclosure.

Referring to FIG. 33, a signal processing circuit 300 may include scramblers 310, modulators 320, a layer mapper 330, a precoder 340, resource mappers 350, and signal generators 360. For example, an operation/function of FIG. 33 may be performed by the processors 202a and 202b and/or the transceivers 36 and 206 of FIG. 32. Hardware elements of FIG. 33 may be implemented by the processors 202a and 202b and/or the transceivers 36 and 206 of FIG. 32. For example, blocks 310 to 360 may be implemented by the processors 202a and 202b of FIG. 32. Alternatively, the blocks 310 to 350 may be implemented by the processors 202a and 202b of FIG. 32 and the block 360 may be implemented by the transceivers 36 and 206 of FIG. 32, and it is not limited to the above-described embodiment.

Codewords may be converted into radio signals via the signal processing circuit 300 of FIG. 33. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 310. Scramble sequences used for scrambling may be generated based on an initialization value, and the initialization value may include ID information of a wireless device. The scrambled bit sequences may be modulated to modulation symbol sequences by the modulators 320. A modulation scheme may include pi/2-Binary Phase Shift Keying (pi/2-BPSK), m-Phase Shift Keying (m-PSK), and m-Quadrature Amplitude Modulation (m-QAM).

Complex modulation symbol sequences may be mapped to one or more transport layers by the layer mapper 330. Modulation symbols of each transport layer may be mapped (precoded) to corresponding antenna port(s) by the precoder 340. Outputs z of the precoder 340 may be obtained by multiplying outputs y of the layer mapper 330 by an N*M precoding matrix W. Herein, N is the number of antenna ports and M is the number of transport layers. The precoder 340 may perform precoding after performing transform precoding (e.g., DFT) for complex modulation symbols. Alternatively, the precoder 340 may perform precoding without performing transform precoding.

The resource mappers 350 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 360 may generate radio signals from the mapped modulation symbols and the generated radio signals may be transmitted to other devices through each antenna. For this purpose, the signal generators 360 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures of FIG. 33. For example, the wireless devices (e.g., 200a and 200b of FIG. 32) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

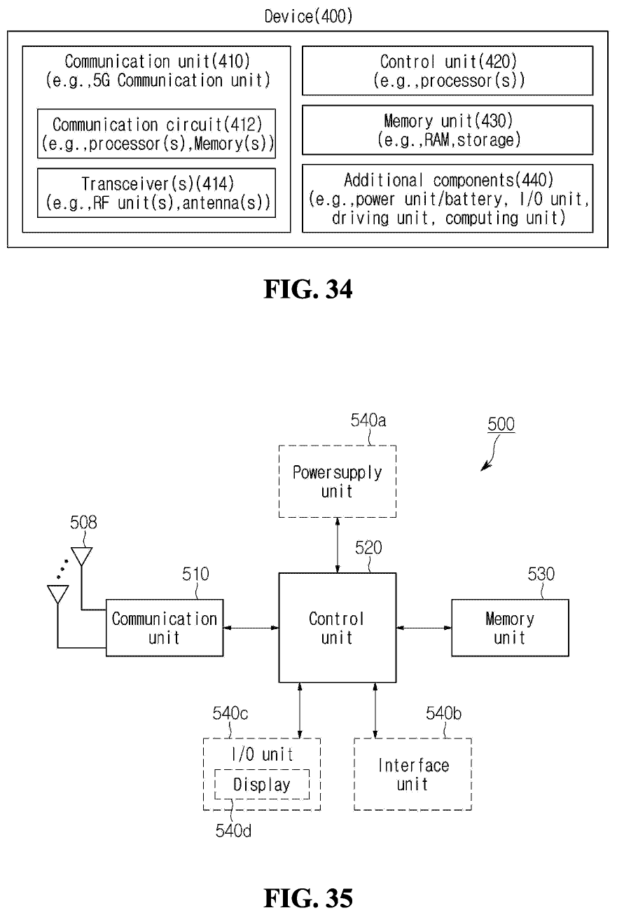

FIG. 34 illustrates a wireless device, in accordance with an embodiment of the present disclosure. The embodiment of FIG. 34 may be combined with various embodiments of the present disclosure.

Referring to FIG. 34, a wireless device 300 may correspond to the wireless devices 200a and 200b of FIG. 32 and include various elements, components, units/portions and/or modules. For example, the wireless device 300 may include a communication unit 310, a control unit (controller) 320, a memory unit (memory) 330 and additional components 340.

The communication unit 410 may include a communication circuit 412 and a transceiver(s) 414. The communication unit 410 may transmit and receive signals (e.g., data, control signals, etc.) to and from other wireless devices or base stations. For example, the communication circuit 412 may include one or more processors 202a and 202b and/or one or more memories 204a and 204b of FIG. 32. For example, the transceiver(s) 414 may include one or more transceivers 206a and 206b and/or one or more antennas 208a and 208b of FIG. 42.

The control unit 420 may be composed of at least one processor set. For example, the control unit 420 may be composed of a set of a communication control processor, an application processor, an electronic control unit (ECU), a graphic processing processor, a memory control processor, etc. The control unit 420 may be electrically coupled with the communication unit 410, the memory unit 430 and the additional components 440 to control overall operation of the wireless device. For example, the control unit 420 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The memory unit 430 may be composed of a random access memory (RAM), a dynamic RAM (DRAM), a read only memory (ROM), a flash memory, a volatile memory, a non-volatile memory and/or a combination thereof. The memory unit 430 may store data/parameters/programs/codes/commands necessary to derive the wireless device 400. In addition, the memory unit 430 may store input/output data/information, etc.

The additional components 440 may be variously configured according to the types of the wireless devices. For example, the additional components 440 may include at least one of a power unit/battery, an input/output unit, a driving unit or a computing unit. Without being limited thereto, the wireless device 400 may be implemented in the form of the robot (FIG. 41, 100a), the vehicles (FIGS. 41, 100b-1 and 100b-2), the XR device (FIG. 41, 100c), the hand-held device (FIG. 41, 100d), the home appliance (FIG. 41, 100e), the IoT device (FIG. 41, 100f), a digital broadcast terminal, a hologram apparatus, a public safety apparatus, an MTC apparatus, a medical apparatus, a Fintech device (financial device), a security device, a climate/environment device, an AI server/device (FIG. 41, 140), the base station (FIG. 41, 120), a network node, etc. The wireless device may be movable or may be used at a fixed place according to use example/service.

FIG. 35 illustrates a hand-held device, in accordance with an embodiment of the present disclosure. FIG. 35 exemplifies a hand-held device applicable to the present disclosure. The hand-held device may include a smartphone, a smart pad, a wearable device (e.g., a smart watch or smart glasses), and a hand-held computer (e.g., a laptop, etc.). The embodiment of FIG. 35 may be combined with various embodiments of the present disclosure.

Referring to FIG. 35, the hand-held device 500 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/440a to 540c may correspond to the blocks 310 to 330/340 of FIG. 34, respectively, and duplicate descriptions are omitted.

The communication unit 510 may transmit and receive signals and the control unit 520 may control the hand-held device 500, and the memory unit 530 may store data and so on. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 540c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

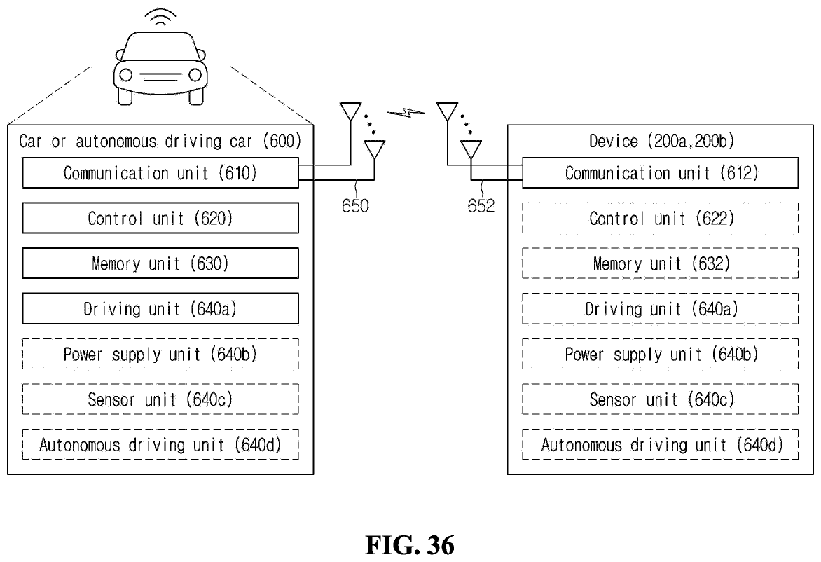

FIG. 36 illustrates a car or an autonomous vehicle, in accordance with an embodiment of the present disclosure. FIG. 36 exemplifies a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited. The embodiment of FIG. 36 may be combined with various embodiments of the present disclosure

Referring to FIG. 36, the car or autonomous driving car 600 may include an antenna unit (antenna) 608, a communication unit (transceiver) 610, a control unit (controller) 620, a driving unit 640a, a power supply unit (power supply) 640b, a sensor unit 640c, and an autonomous driving unit 640d. The antenna unit 650 may be configured as part of the communication unit 610. The blocks 610/630/640a to 640d correspond to the blocks 510/530/540 of FIG. 35, and duplicate descriptions are omitted.

The communication unit 610 may transmit and receive signals (e.g., data, control signals, etc.) to and from external devices such as another vehicle, a base station (e.g., a base station, a road side unit, etc.), and a server. The control unit 620 may control the elements of the car or autonomous driving car 600 to perform various operations. The control unit 620 may include an electronic control unit (ECU). The driving unit 640a may drive the car or autonomous driving car 600 on the ground. The driving unit 640a may include an engine, a motor, a power train, wheels, a brake, a steering device, etc. The power supply unit 640b may supply power to the car or autonomous driving car 600, and include a wired/wireless charging circuit, a battery, etc. The sensor unit 640c may obtain a vehicle state, surrounding environment information, user information, etc. The sensor unit 640c may include an inertial navigation unit (IMU) sensor, a collision sensor, a wheel sensor, a speed sensor, an inclination sensor, a weight sensor, a heading sensor, a position module, a vehicle forward/reverse sensor, a battery sensor, a fuel sensor, a tire sensor, a steering sensor, a temperature sensor, a humidity sensor, an ultrasonic sensor, an illumination sensor, a brake pedal position sensor, and so on. The autonomous driving sensor 640d may implement technology for maintaining a driving lane, technology for automatically controlling a speed such as adaptive cruise control, technology for automatically driving the car along a predetermined route, technology for automatically setting a route when a destination is set and driving the car, etc.

For example, the communication unit 610 may receive map data, traffic information data, etc. from an external server. The autonomous driving unit 640d may generate an autonomous driving route and a driving plan based on the acquired data. The control unit 620 may control the driving unit 640a (e.g., speed/direction control) such that the car or autonomous driving car 600 moves along the autonomous driving route according to the driving plane. During autonomous driving, the communication unit 610 may aperiodically/periodically acquire latest traffic information data from an external server and acquire surrounding traffic information data from neighboring cars. In addition, during autonomous driving, the sensor unit 640c may acquire a vehicle state and surrounding environment information. The autonomous driving unit 640d may update the autonomous driving route and the driving plan based on newly acquired data/information. The communication unit 610 may transmit information such as a vehicle location, an autonomous driving route, a driving plan, etc. to the external server. The external server may predict traffic information data using AI technology or the like based on the information collected from the cars or autonomous driving cars and provide the predicted traffic information data to the cars or autonomous driving cars.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL AVAILABILITY

The embodiments of the present disclosure are applicable to various radio access systems. Examples of the various radio access systems include a 3^{rd} generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method of operating a user equipment (UE) in a wireless communication system, the method comprising:
transmitting a first message requesting addition of a positioning reference signal (PRS) source;
receiving a second message including information related to at least one other device to transmit a PRS;
receiving at least one PRS transmitted by the at least one other device through a resource allocated by a base station; and
performing an operation for positioning based on the at least one PRS,
wherein the at least one device comprises at least one UE.

2. The method of claim 1, wherein the first message is transmitted to the base station through another UE connected to the UE through a sidelink, in case that the UE is out of coverage of the base station.

3. The method of claim 1, wherein the second message comprises information related to a plurality of PRS source candidates, and
wherein the at least one other UE is at least one PRS source selected based on a reliability coefficient among the plurality of PRS source candidates.

4. The method of claim 3, wherein the reliability coefficient is determined based on the number of mobile nodes among PRS sources used for positioning of a UE notified as a PRS source candidate.

5. The method of claim 1, further comprising:
receiving assistance data for positioning from a positioning server;
attempting to receive PRSs based on the assistance data; and
determining that the number of PRS sources satisfying a condition is less than a threshold, based on a measurement result for the PRSs.

6. The method of claim 1, wherein the first message comprises at least one of an indicator for a request to add a PRS source, the number of necessary PRS sources, a cause of determining lack of PRS sources or information related to recently received PRSs.

7-15. (canceled)

16. A user equipment (UE) in a wireless communication system, the UE comprising:
a transceiver; and
a processor coupled to the transceiver and configured to:
transmit a first message requesting addition of a positioning reference signal (PRS) source;
receive a second message including information related to at least one other device to transmit a PRS;
receive at least one PRS transmitted by the at least one other device through a resource allocated by a base station; and
perform an operation for positioning based on the at least one PRS,
wherein the at least one device comprises at least one UE.

17-18. (canceled)

19. A device comprising at least one memory and at least one processor functionally connected to the at least one memory, wherein the at least one processor controls the device to:
transmit a first message requesting addition of a positioning reference signal (PRS) source;
receive a second message including information related to at least one other device to transmit a PRS;
receive at least one PRS transmitted by the at least one other device through a resource allocated by a base station; and
perform an operation for positioning based on the at least one PRS,
wherein the at least one device comprises at least one UE.

20. (canceled)

21. The UE of claim 16, wherein the first message is transmitted to the base station through another UE connected to the UE through a sidelink, in case that the UE is out of coverage of the base station.

22. The UE of claim 16, wherein the second message comprises information related to a plurality of PRS source candidates, and
wherein the at least one other UE is at least one PRS source selected based on a reliability coefficient among the plurality of PRS source candidates.

23. The UE of claim 22, wherein the reliability coefficient is determined based on the number of mobile nodes among PRS sources used for positioning of a UE notified as a PRS source candidate.

24. The UE of claim 16, wherein the processor performs configured to:
receive assistance data for positioning from a positioning server;
attempt to receive PRSs based on the assistance data; and
determine that the number of PRS sources satisfying a condition is less than a threshold, based on a measurement result for the PRSs.

25. The UE of claim 16, wherein the first message comprises at least one of an indicator for a request to add a PRS source, the number of necessary PRS sources, a cause of determining lack of PRS sources or information related to recently received PRSs.
